(19) United States
(12) Patent Application Publication
(10) Pub. No.: US 2024/0340746 A1
(43) Pub. Date: Oct. 10, 2024

(54) GROUP BASED BEAM REPORT ENHANCEMENT FOR MOBILITY

(71) Applicant: QUALCOMM Incorporated, San Diego, CA (US)

(72) Inventors: Tianyang BAI, Somerville, NJ (US); Yan ZHOU, San Diego, CA (US); Jelena DAMNJANOVIC, Del Mar, CA (US)

(21) Appl. No.: 18/297,588

(22) Filed: Apr. 7, 2023

(51) Int. Cl. H04W 36/32; H04W 36/00

(52) U.S. Cl. CPC H04W 36/32; H04W 36/0058

(57) ABSTRACT

Methods, systems, and devices for wireless communications are described. A user equipment (UE) may perform group-based reporting based on channel measurement resource (CMR) sets corresponding to a candidate cell. In some examples, the UE may transmit a group-based beam report indicating measurements for reference signals from the candidate cell that can be simultaneously received. For example, the UE may measure signal strengths associated with one or more reference signal pairs, where each reference signal pair includes a respective first reference signal from a first CMR set and a respective second reference signal from a second CMR set.

### FIELD OF TECHNOLOGY

The following relates to wireless communications, including group based beam report enhancement for mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support group based beam report enhancement for layer 1 (L1)/layer 2 (L2) triggered mobility (LTM). For example, a user equipment (UE) may perform group-based reporting in which the UE measures multiple channel measurement resource (CMR) sets corresponding to a candidate cell and reports the measurements associated with multiple CMR sets. In some examples, the UE may transmit a group-based measurement report indicating measurements of reference signals from the candidate cell that were received by the UE via the CMR sets, which in some cases may be received concurrently or simultaneously at the UE. For example, the UE may monitor the CMR sets for reference signals from the candidate cell and measure signal strengths associated with one or more reference signal pairs, where each reference signal pair includes a respective first reference signal from a first CMR set and a respective second reference signal from a second CMR set. That is, each reference signal in the reference signal pair may correspond to a different CMR set of the candidate cell. Additionally, or alternatively, the UE may perform group-based reporting of one or more additional CMR sets that correspond to a second cell (e.g., a serving cell or a different candidate cell). Additionally, or alternatively, the first CMR set may correspond to the candidate cell while the second CMR set may correspond to a second cell.

A method for wireless communications at a UE is described. The method may include receiving a control signal indicating a first resource set and a second resource set that are allocated to the UE for group-based channel measurement reporting for a UE mobility procedure, where both the first resource set and the second resource set are associated with a candidate cell for the UE mobility procedure, monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set, and transmitting a group-based measurement report for the candidate cell, the group-based measurement report indicating one or more measurements of the set of multiple reference signals associated with the candidate cell based on monitoring the first and second resource sets.

An apparatus for wireless communications at a UE is described. The apparatus may include a processor, memory coupled with the processor, and instructions stored in the memory. The instructions may be executable by the processor to cause the apparatus to receive a control signal indicating a first resource set and a second resource set that are allocated to the UE for group-based channel measurement reporting for a UE mobility procedure, where both the first resource set and the second resource set are associated with a candidate cell for the UE mobility procedure, monitor the first and second resource sets for a set of multiple reference signals associated with the candidate cell in accordance with the UE mobility procedure, the set of multiple reference signals including a first subset of reference signals associated with the first resource set and a second subset of reference signals associated with the second resource set, and transmit a group-based measurement report for the candidate cell, the group-based measurement report indicating one or more measurements of the set of multiple reference signals associated with the candidate cell based on monitoring the first and second resource sets.

Another apparatus for wireless communications at a UE is described. The apparatus may include means for receiving a control signal indicating a first resource set and a second resource set that are allocated to the UE for group-based channel measurement reporting for a UE mobility procedure, where both the first resource set and the second resource set are associated with a candidate cell for the UE mobility procedure, means for monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set, and means for transmitting a group-based measurement report for the candidate cell, the group-based measurement report indicating one or more measurements of the set of multiple reference signals associated with the candidate cell based on monitoring the first and second resource sets.

A non-transitory computer-readable medium storing code for wireless communications at a UE is described. The code may include instructions executable by a processor to receive a control signal indicating a first resource set and a second resource set that are allocated to the UE for group-based channel measurement reporting for a UE mobility procedure, where both the first resource set and the second resource set are associated with a candidate cell for the UE mobility procedure, monitor the first and second resource sets for a set of multiple reference signals associated with the candidate cell in accordance with the UE mobility procedure, the set of multiple reference signals including a first subset of reference signals associated with the first resource set and a second subset of reference signals associated with the second resource set, and transmit a group-based measurement report for the candidate cell, the group-based measurement report indicating one or more measurements of the set of multiple reference signals associated with the candidate cell based on monitoring the first and second resource sets.

Some examples of the method, apparatuses, and non-transitory computer-readable medium described herein may further include operations, features, means, or instructions for receiving a first reference signal of the first subset of reference signals via one or more time resources of the first resource set based on the monitoring and receiving a second reference signal of the second subset of reference signals via one or more time resources of the second resource set that at least partially overlap in time with the one or more time resources of the first resource set based on the monitoring.

In some examples of the method, apparatuses, and non-transitory computer-readable medium described herein, transmitting the group-based measurement report may include operations, features, means, or instructions for transmitting a first reference signal receive power value associated with the first reference signal based on the monitoring and transmitting a second reference signal receive power value associated with the second reference signal based on the monitoring.

In some examples of the method, apparatuses, and non-transitory computer-readable medium described herein, transmitting the group-based measurement report may include operations, features, means, or instructions for transmitting the group-based measurement report based on a priority rule for group-based channel measurement reporting.

In some examples of the method, apparatuses, and non-transitory computer-readable medium described herein, transmitting the group-based measurement report may include operations, features, means, or instructions for transmitting the group-based measurement report via the time resources based on the first cell identifier being smaller than the second cell identifier in accordance with the priority rule.

In some examples of the method, apparatuses, and non-transitory computer-readable medium described herein, receiving the control signal may include operations, features, means, or instructions for receiving the control signal indicating a first cell identifier associated with the candidate cell.

In some examples of the method, apparatuses, and non-transitory computer-readable medium described herein, receiving the control signal may include operations, features, means, or instructions for receiving the control signal via a field in a radio resource control message.

In some examples of the method, apparatuses, and non-transitory computer-readable medium described herein, receiving the control signal may include operations, features, means, or instructions for receiving the control signal indicating a channel state information reference signal associated with the candidate cell.

In some examples of the method, apparatuses, and non-transitory computer-readable medium described herein, a configuration corresponding to the channel state information reference signal indicates that the first resource set and the second resource set may be associated with the candidate cell.

In some examples of the method, apparatuses, and non-transitory computer-readable medium described herein, receiving the control signal may include operations, features, means, or instructions for receiving the control signal via a serving cell.

Some examples of the method, apparatuses, and non-transitory computer-readable medium described herein may further include operations, features, means, or instructions for receiving the control signaling indicating a third resource set and a fourth resource set that may be allocated to the UE for group-based channel measurement reporting for the UE mobility procedure, where both the third resource set and the fourth resource set may be associated with a second cell for the UE mobility procedure, monitoring the third and fourth resource sets for a second set of multiple reference signals associated with the second cell in accordance with the UE mobility procedure, the second set of multiple reference signals including a third subset of reference signals associated with the third resource set and a fourth subset of reference signals associated with the fourth resource set, and transmitting the group-based measurement report for the second cell, the group-based measurement report indicating one or more measurements of the second set of multiple reference signals associated with the second cell based on monitoring the third and fourth resource sets.

Some examples of the method, apparatuses, and non-transitory computer-readable medium described herein may further include operations, features, means, or instructions for receiving a first reference signal pair associated with the set of multiple reference signals via one or more time resources of the first and second resource sets based on the monitoring and receiving a second reference signal pair associated with the second set of multiple reference signals via one or more time resources of the third and fourth resource sets that at least partially overlap in time with the one or more time resources of the first and second resource sets, where the UE may be capable of receiving each reference signal of the first reference signal pair and each reference signal of the second reference signal pair over the one or more overlapping time resources based on the monitoring.

In some examples of the method, apparatuses, and non-transitory computer-readable medium described herein, the second cell may be associated with a second candidate cell or a serving cell.

In some examples of the method, apparatuses, and non-transitory computer-readable medium described herein, the candidate cell and the second cell may be associated with a same frequency or a same intra-frequency measurement as a serving cell.

In some examples of the method, apparatuses, and non-transitory computer-readable medium described herein, the candidate cell and the second cell may be associated with a different frequency or a different intra-frequency measurement as a serving cell.

In some examples of the method, apparatuses, and non-transitory computer-readable medium described herein, the third resource set may be associated with a first set of transmission beams for the third subset of reference signals and the fourth resource set may be associated with a second set of transmission beams for the fourth subset of reference signals.

In some examples of the method, apparatuses, and non-transitory computer-readable medium described herein, the third resource set may be associated with a first channel measurement resource set and the fourth resource set may be associated with a second channel measurement resource set.

In some examples of the method, apparatuses, and non-transitory computer-readable medium described herein, the first resource set may be associated with a first set of transmission beams for the first subset of reference signals and the second resource set may be associated with a second set of transmission beams for the second subset of reference signals.

In some examples of the method, apparatuses, and non-transitory computer-readable medium described herein, the first resource set includes a first channel measurement resource set or a first interference measurement resource set and the second resource set includes a second channel measurement resource set or a second interference measurement resource set.

In some examples of the method, apparatuses, and non-transitory computer-readable medium described herein, receiving the control signal may include operations, features, means, or instructions for receiving the control signal via a layer 1 (L1) message or a layer 2 (L2) message, where the UE mobility procedure includes an L1/L2 triggered mobility (LTM) procedure.

In some examples of the method, apparatuses, and non-transitory computer-readable medium described herein, receiving the control signal may include operations, features, means, or instructions for receiving the control signal via the layer 1 message, the layer 1 message including a downlink control information and receiving the control signal via the layer 2 message, the layer 2 message including a medium access control (MAC) control element (MAC-CE).

In some examples of the method, apparatuses, and non-transitory computer-readable medium described herein, the candidate cell may be associated with a deactivated serving cell or a non-serving cell.

A method for wireless communications at a UE is described. The method may include receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure, monitoring the first resource set for a first set of multiple reference signals associated with the candidate cell in accordance with the UE mobility procedure and the second resource set for a second set of multiple reference signals associated with the second cell in accordance with the UE mobility procedure, and transmitting a group-based measurement report indicating one or more measurements of the first set of multiple reference signals associated with the candidate cell and one or more measurements of the second set of multiple reference signals associated with the second cell based on monitoring the first and second resource sets.

An apparatus for wireless communications at a UE is described. The apparatus may include a processor, memory coupled with the processor, and instructions stored in the memory. The instructions may be executable by the processor to cause the apparatus to receive a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure, monitor the first resource set for a first set of multiple reference signals associated with the candidate cell in accordance with the UE mobility procedure and the second resource set for a second set of multiple reference signals associated with the second cell in accordance with the UE mobility procedure, and transmit a group-based measurement report indicating one or more measurements of the first set of multiple reference signals associated with the candidate cell and one or more measurements of the second set of multiple reference signals associated with the second cell based on monitoring the first and second resource sets.

Another apparatus for wireless communications at a UE is described. The apparatus may include means for receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure, means for monitoring the first resource set for a first set of multiple reference signals associated with the candidate cell in accordance with the UE mobility procedure and the second resource set for a second set of multiple reference signals associated with the second cell in accordance with the UE mobility procedure, and means for transmitting a group-based measurement report indicating one or more measurements of the first set of multiple reference signals associated with the candidate cell and one or more measurements of the second set of multiple reference signals associated with the second cell based on monitoring the first and second resource sets.

A non-transitory computer-readable medium storing code for wireless communications at a UE is described. The code may include instructions executable by a processor to receive a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure, monitor the first resource set for a first set of multiple reference signals associated with the candidate cell in accordance with the UE mobility procedure and the second resource set for a second set of multiple reference signals associated with the second cell in accordance with the UE mobility procedure, and transmit a group-based measurement report indicating one or more measurements of the first set of multiple reference signals associated with the candidate cell and one or more measurements of the second set of multiple reference signals associated with the second cell based on monitoring the first and second resource sets.

In some examples of the method, apparatuses, and non-transitory computer-readable medium described herein, the first and second resource sets may be each associated with multiple cells.

In some examples of the method, apparatuses, and non-transitory computer-readable medium described herein, transmitting the group-based measurement report may include operations, features, means, or instructions for transmitting one or more reference signal identifiers associated with the first set of multiple reference signals and one or more reference signal identifiers associated with the second set of multiple reference signals and transmitting one or more reference signal receive power values associated with the first set of multiple reference signals and one or more reference signal receive power values associated with the second set of multiple reference signals.

In some examples of the method, apparatuses, and non-transitory computer-readable medium described herein, the first set of multiple reference signals may be associated with a first set of transmission beams and the second set of multiple reference signals may be associated with a second set of transmission beams.

A method for wireless communications at a first wireless device is described. The method may include transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure and receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

An apparatus for wireless communications at a first wireless device is described. The apparatus may include a processor, memory coupled with the processor, and instructions stored in the memory. The instructions may be executable by the processor to cause the apparatus to transmit, to a UE, a control signal indicating a first resource set and a second resource set that are allocated to the UE for group-based channel measurement reporting for a UE mobility procedure, where both the first resource set and the second resource set are associated with a candidate cell for the UE mobility procedure and receive, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

Another apparatus for wireless communications at a first wireless device is described. The apparatus may include means for transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure and means for receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

A non-transitory computer-readable medium storing code for wireless communications at a first wireless device is described. The code may include instructions executable by a processor to transmit, to a UE, a control signal indicating a first resource set and a second resource set that are allocated to the UE for group-based channel measurement reporting for a UE mobility procedure, where both the first resource set and the second resource set are associated with a candidate cell for the UE mobility procedure and receive, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

Some examples of the method, apparatuses, and non-transitory computer-readable medium described herein may further include operations, features, means, or instructions for transmitting, to the UE, a control message indicating the UE to switch to the candidate cell.

### BRIEF DESCRIPTION OF THE DRAWINGS

FIG. 1 shows an example of a wireless communications system that supports group based beam report enhancement for layer 1 (L1)/layer 2 (L2) triggered mobility (LTM) in accordance with one or more aspects of the present disclosure.

FIG. 2 shows an example of a wireless communications system that supports group based beam report enhancement for LTM in accordance with one or more aspects of the present disclosure.

FIGS. 3A and 3B show examples of wireless communications systems that supports group based beam report enhancement for LTM in accordance with one or more aspects of the present disclosure.

FIG. 4 shows an example of a process flow that supports group based beam report enhancement for LTM in accordance with one or more aspects of the present disclosure.

FIGS. 5 and 6 show block diagrams of devices that support group based beam report enhancement for LTM in accordance with one or more aspects of the present disclosure.

FIG. 7 shows a block diagram of a communications manager that supports group based beam report enhancement for LTM in accordance with one or more aspects of the present disclosure.

FIG. 8 shows a diagram of a system including a device that supports group based beam report enhancement for LTM in accordance with one or more aspects of the present disclosure.

FIGS. 9 and 10 show block diagrams of devices that support group based beam report enhancement for LTM in accordance with one or more aspects of the present disclosure.

FIG. 11 shows a block diagram of a communications manager that supports group based beam report enhancement for LTM in accordance with one or more aspects of the present disclosure.

FIG. 12 shows a diagram of a system including a device that supports group based beam report enhancement for LTM in accordance with one or more aspects of the present disclosure.

FIGS. 13 through 17 show flowcharts illustrating methods that support group based beam report enhancement for LTM in accordance with one or more aspects of the present disclosure.

### DETAILED DESCRIPTION

A user equipment (UE) may support communications with multiple transmission and reception points (TRPs). For example, the UE may simultaneously receive signaling from multiple TRPs. To support multi-TRP (mTRP), the UE may transmit one or more channel state information (CSI) reports (e.g., a group-based measurement report) to one or more of the multiple TRPs. A CSI report may include information indicative of one or more measured signal strengths (e.g., reference signal receive power (RSRP), as measured by the UE) and information that indicates one or more channel measurement resources (CMRs) (e.g., reference signals) to which the measured signal strengths correspond. In some aspects, for example, a first TRP may transmit reference signals via a first CMR set while switching between different transmit beams and a second TRP may transmit reference signals via a second CMR set while switching between different transmit beams. As such, the UE may indicate which reference signals have a relatively greatest signal strength using a group-based beam report. A group-based beam report may refer to a report that includes multiple measurements of multiple cells and in some cases may include multiple beam measurements (e.g., measurements, by the UE, of beams of a cell) for multiple cells.

In order to reduce latency during a cell switch, layer 1 (L1)/layer 2 (L2) triggered mobility (LTM) may be utilized. For example, a serving cell (e.g., supported by a network entity) may use L1 (e.g., downlink control information (DCI)) or L2 (e.g., medium access control (MAC) control element (MAC-CE)) signaling to trigger a cell switch for a UE from a serving cell to a candidate cell, which may be a cell that the UE is not communicating with or connected to. The candidate cell may be a deactivated serving cell or a non-serving cell. In some instances, the UE may be configured to measure and report reference signals from the candidate cell. For example, an L1 candidate cell report may include measurements from one or more serving cells, candidate cells, or both. However, group-based reporting may only be supported for serving cells.

According to aspects herein, a candidate cell may be associated with one or more sets of CMRs, and each CMR set may correspond to a different TRP. That is, a first TRP may transmit reference signals using resources within a first CMR and a second TRP may transmit reference signals using resources within a second CMR set. A UE may perform group-based reporting based on the CMR sets corresponding to the candidate cell.

In some examples, the UE may transmit a group-based measurement report indicating measurements for reference signals from the candidate cell. For example, the UE may measure signal strengths associated with one or more reference signal pairs, where each reference signal pair includes a respective first reference signal from the first CMR set and a respective second reference signal from the second CMR set. That is, each reference signal in the reference signal pair may correspond to a different CMR set from the candidate cell. Additionally, or alternatively, the UE may perform group-based reporting of one or more additional CMR sets that correspond to a second cell (e.g., a serving cell or a different candidate cell). Additionally, or alternatively, the first CMR set may correspond to the candidate cell while the second CMR set may correspond to a second cell.

Aspects of the disclosure are initially described in the context of wireless communications systems. Additional aspects of this disclosure are described in the context of process flows. Aspects of the disclosure are further illustrated by and described with reference to apparatus diagrams, system diagrams, and flowcharts that relate to group based beam report enhancement for LTM.

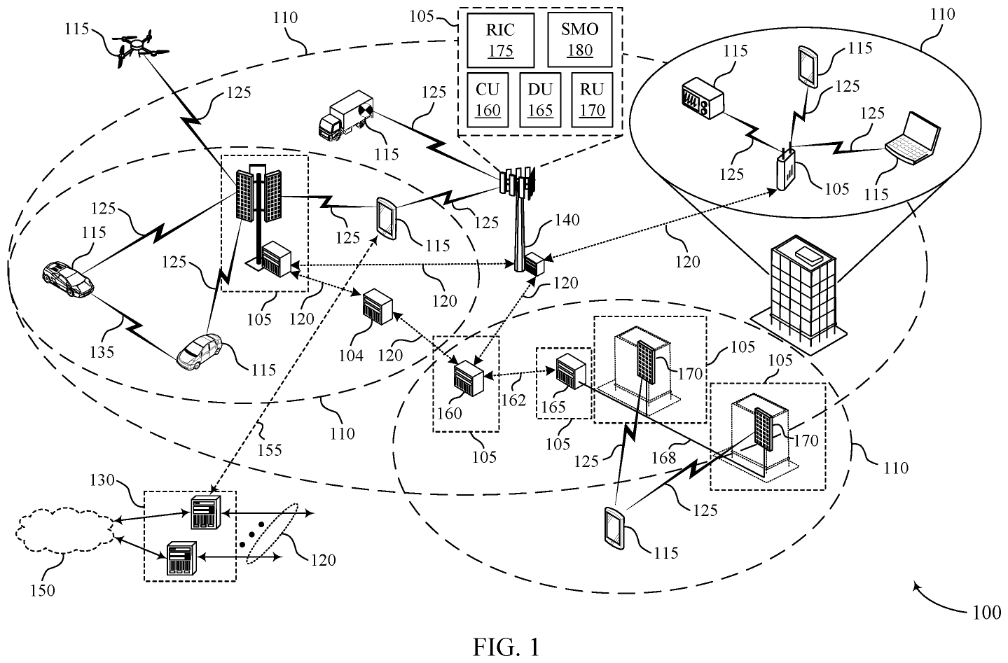

FIG. 1 shows an example of a wireless communications system 100 that supports group based beam report enhancement for LTM in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support group based beam report enhancement for LTM as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna array's (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Wireless communications system 100 may support communications for a UE 115 via multiple TRPs (e.g., multiple RUs 170), which may be supported by one or more network entities 105 and associated with one or more cells. For example, a UE 115 may receive signaling from multiple TRPs and may transmit a CSI report, such as a group-based measurement report, to one or more of the multiple TRPs. The CSI report may include information indicative of one or more measured signal strengths (e.g., RSRP) and information indicative of which one or more CMRs (e.g., reference signals) to which the measured signal strengths correspond. For example, a first TRP may transmit reference signals via a first CMR set while switching between different transmit beams and a second TRP may transmit reference signals via a second CMR set while switching between different transmit beams. As such, the UE 115 may indicate which reference signals have a relatively greatest signal strength through a group-based beam report. In some cases, the group-based beam report may also indicate which transmit beams are associated with the measured signal strengths (e.g., different transmit beams may correspond to different resources within a given CMR set).

In order to reduce latency during a cell switch, LTM may be utilized. For example, a serving cell may use L1 (e.g., DCI) or L2 (e.g., MAC-CE) signaling to trigger a cell switch for the UE 115, to a candidate cell from the serving cell. The candidate cell may be a deactivated serving cell or a non-serving cell. In some instances, the UE 115 may be configured to measure and report reference signals from the candidate cell. For example, a candidate cell may be associated with one or more sets of CMRs, and each CMR set may correspond to a different TRP. That is, a first TRP may transmit reference signals using resources of a first CMR and a second TRP may transmit reference signals using resources of a second CMR set. A UE 115 may perform group-based reporting by monitoring the first and second CMR sets and measuring the reference signals received by the UE 115. The UE 115 may transmit a group-based beam report based on one or more measurements from the candidate cell.

In some examples, the UE 115 may transmit a group-based measurement report indicating measurements for reference signals from the candidate cell, which in some cases may be received concurrently or simultaneously. For example, the UE 115 may measure signal strengths associated with one or more reference signal pairs, where each reference signal pair includes a respective first reference signal from the first CMR set and a respective second reference signal from the second CMR set. That is, each reference signal in the reference signal pair may correspond to a different CMR set corresponding to the candidate cell. Additionally, or alternatively, the UE 115 may perform group-based reporting on one or more additional CMR sets that correspond to a second cell (e.g., a serving cell or a different candidate cell). Additionally, or alternatively, the first CMR set may correspond to the candidate cell while the second CMR set may correspond to a second cell.

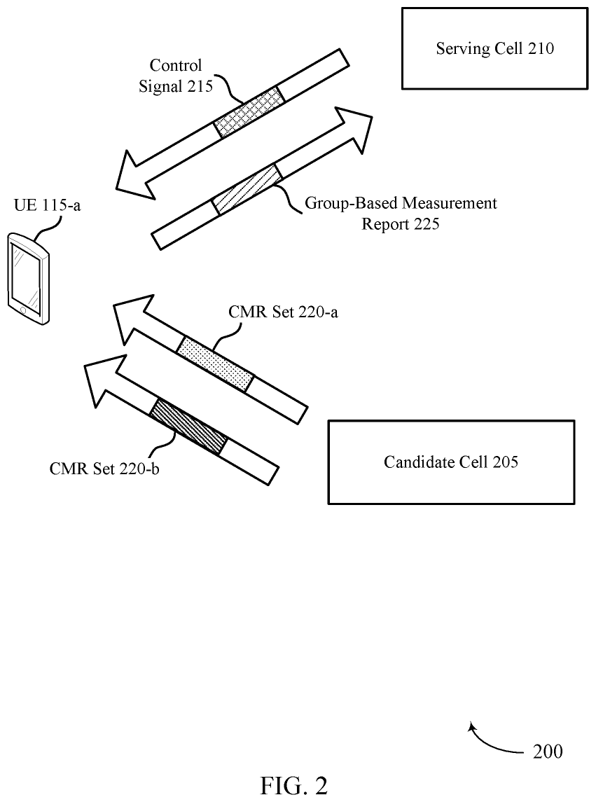

FIG. 2 shows an example of a wireless communications system 200 that supports group based beam report enhancement for LTM in accordance with one or more aspects of the present disclosure. The wireless communications system 200 may implement aspects of the wireless communications system 100. For example, the wireless communications system 200 may include a UE 115-a which may be an example of a UE 115, as described with reference to FIG. 1. Additionally, the wireless communications system 200 may include a candidate cell 205 and a serving cell 210 which may each be an example of a network entity 105, as described with reference to FIG. 1.

A described herein, a UE 115-a may measure and report measurements from a candidate cell 205 for a cell switch procedure (e.g., UE mobility procedure). For instance, the UE 115-a may switch from a serving cell 210 to a candidate cell 205. In order to reduce latency during the cell switch, the UE 115-a, the serving cell 210, or both, may use LTM. In some instances, the LTM may involve a group-based report (e.g., a group-based measurement report 225) including measurements from the candidate cell 205.

In some cases, the UE 115-a may receive a control signal 215, from the serving cell 210, indicating resources for a UE mobility procedure. For example, the serving cell 210 may allocate or indicate a first resource set (e.g., a CMR set 220-a) and a second resource set (e.g., a CMR set 220-b) for the UE 115-a to use for the UE mobility procedure. The CMR set 220-a and the CMR set 220-b may correspond to or be associated with the candidate cell 205 such that the candidate cell 205 is configured to transmit signals using the CMR sets 220. That is, the candidate cell 205 may be configured with multiple, in this example two (2), CMR sets 220 and the candidate cell 205 may use the multiple CMR sets 220 for transmission (or reception) of signals. Although referred to as a CMR, other types of resource sets, such as an interference measurement resource (IMR) set, may be considered without departing from the scope of the present disclosure. For instance, one or more of the CMR sets 220 may be an IMR set.

In some cases, a serving cell 210 may transmit a control signal 215, which may include a field indicating information for the UE mobility procedure. The serving cell 210 may configure the candidate cell 205 in a cell list, which may be indicated by the field. For example, the field may indicate an index of a cell list that includes multiple cells for the UE. Additionally, or alternatively, the field may indicate a physical cell ID (PCI) of a candidate cell 205. In some instances, the serving cell 210 may transmit the control signal 215 to the UE 115-a via an L1 message (e.g., DCI), via an L2 message (e.g., MAC-CE), or via RRC.

In some cases, the control signal 215 may indicate that a CSI-RS from the CMR sets 220 corresponds to the candidate cell 205. That is, the control signal 215 may indicate that the CMR sets 220 correspond to the candidate cell 205. For example, a candidate cell synchronization signal block (SSB) may define a transmission configuration indicator (TCI) state of the CSI-RS, which may be used by the candidate cell 205 for transmitting signals using the CMR sets 220.

In some cases, the UE 115-a may perform a group-based report based on the CMR sets 220 corresponding to the candidate cell 205. For example, the UE 115-a may transmit a group-based measurement report 225 to the serving cell 210. The UE 115-a may report one or more reference signal pairs, which may be received via one or more overlapping time resources, as well as respective RSRPs (e.g., RSRP values) for each reference signal of the reference signal pairs. In some instances, a cell identifier (e.g., cell ID) may be included in the group-based measurement report 225 to indicate to which cell each of the reference signals correspond, but may be excluded if the reference signals correspond to the same cell.

In some cases, a UE 115 may include differential reporting, such as L1-RSRP reporting, across multiple (e.g., all) beam groups in a CSI report. In some examples, the UE 115-a may include, in the CSI report, a 1-bit indicator of the CMR set 220 associated with the largest RSRP value in all groups (where the strongest beam may be assumed to be in a first group). The 1 bit indicator may be set to ‘0’ to indicate that the first reported CMR in each row corresponds to a first CMR set 220-a. Additionally, or alternately, the 1-bit indicator may be set to ‘I’ to indicate that the first reported CMR in each row comes from a second CMR set 220-b. Further, uplink control information (UCI) payload partitioning, which may be used for sending the CSI report as a group-based measurement report 225, may have defined or set quantities of bits for reporting. For example, the UCI payload partitioning may be set to 7/4 bits for a first and second CSI-RS resource indicator (CRI) in the first beam group and 4 bits for beams in other groups. In some instances, the UE 115-a may report a number of groups N and a number of beams per group M. The UE 115-a may receive the different beams within a group (e.g., pair) simultaneously (e.g., via one or more overlapping time resources). The serving cell 210 may configure N, via RRC or other control signaling, based on a capability (e.g., UE 115-a capability) of Nₘₐₓ={1,2,3,4}.

In some cases, the group-based measurement report 225 (e.g., L1-RSRP reporting) may use 7 bits to report RSRP for the strongest CRI (e.g., CRI with the largest RSRP). That is, the group-based measurement report 225 may report a 7 bit RSRP (e.g., the greatest RSRP reported, in absolute or full terms, via the 7 bits) for the strongest CRI. For the remaining CRI(s), the group-based measurement report 225 may report a 4 bit differential RSRP (e.g., in a range of [0,−30] dB with a 2 dB step size) and a reference to the RSRP of the strongest CRI. Thus, the group-based measurement report 225 may reduce overhead by implementing differential reporting. In some instances, in the group-based measurement report 225 may include the CRI indexed within each CMR set 220.

Additional details of a UCI example including a group-based measurement report 225 in which Nis equal to 2 and a M is equal to 2 are illustrated by Table 1, shown below. In Table 1, the CMR (e.g., reference signal) associated with the strongest or greatest RSRP measurement may be in an example CMR set A, which may be indicated by the first beam group (e.g., pair). Similarly, the CMR associated with the weaker RSRP measurement may be in an example CMR set B. This CMR may be the following CMR in the first beam group (e.g., also indicated by the first beam group). The second beam group may include a second CMR (e.g., the second strongest CRI) from the example CMR set A which may be followed by a second CMR from the example CMR set B.

TABLE 1
Example Group-Based Measurement Report in UCI
1 bit indicator of the CMR set associated with the largest
RSRP value in all groups associated with the candidate cell

| | | |
|---|---|---|
| 1^{st} report group | CRI + 7 bit RSRP | CRI + 4 bit RSRP |
| of beams | (absolute value for | (differential value) |
| | largest RSRP) (CMR | (CMR from CMR set B) |
| | from CMR set A) | |
| 2^{nd} report group | CRI + 4 bit RSRP | CRI + 4 bit RSRP |
| of beams | (differential value) | (differential value) |
| | (CMR from CMR set A) | (CMR from CMR set B) |

In some cases, each CMR set 220 may correspond to beams from a respective TRP. Further, CMRs in the same report group may correspond to different CMR sets 220. For example, the control signal 215 may allocate a first CMR set (e.g., a CMR set 220-a) and a second CMR set (e.g., a CMR set 220-b) to the UE 115-a. In some instances, the CMR set 220-a and the CMR set 220-b may correspond to the candidate cell 205. That is, the UE 115-a may be configured with 2 CMR sets 220 from the candidate cell 205.

In some cases, the group-based measurement report 225 associated with the candidate cell 205 may overlap with a report (e.g., a second report) from a different cell. In these cases, the UE 115-a may transmit the group-based measurement report 225 based on a priority rule for group-based reporting. For example, multiple group based reports (e.g., the group-based measurement report 225 and the second report) from different cells may overlap in a physical uplink control channel (PUCCH). One or more events may trigger the group-based reports. In some instances, the group-based measurement report 225 for the candidate cell may be associated with a first cell identifier (cell ID) (e.g., a first candidate cell ID) and the second report may be associated with a second cell identifier (e.g., a second candidate cell ID or a serving cell ID). The group-based report associated with the serving cell ID, or the smallest candidate cell ID may have a higher priority. Thus, the UE 115-a may transmit the group-based measurement report 225 based on the first cell ID being smaller than the second cell ID.

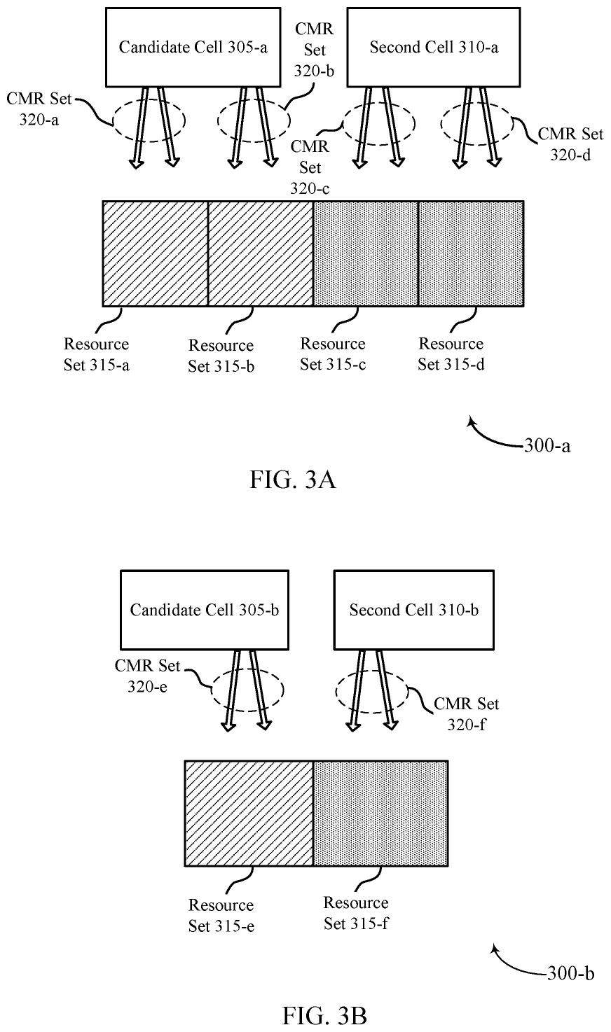

FIGS. 3A and 3B illustrate examples of wireless communications systems 300-a and 300-b that supports group based beam report enhancement for LTM in accordance with one or more aspects of the present disclosure. The wireless communications system 300-a and 300-b may implement aspects of the wireless communications system 100 and the wireless communications system 200. For example, the wireless communications system 300-a and 300-b may include a candidate cell 305-a and a candidate cell 305-b, which may each be examples of a candidate cell 205, as described with reference to FIG. 1. Additionally, the wireless communications system 300-a and 300-b may include one or more CMR sets 320 which may be examples of a CMR set 220, as described with reference to FIG. 1.

In some cases, a group-based measurement report (e.g., a group-based measurement report as described herein) may be linked (e.g., correspond) to multiple cells. In some instances, 2 CMR sets may correspond to each of the linked cells. For example, the group-based measurement report may correspond to a candidate cell 305-a and a second cell 310-a. The second cell 310-a may be a different candidate cell or a serving cell, which may be an example of a serving cell 210, as described with respect to FIG. 1. A serving cell may transmit control signaling indicating the resource sets 315. These resource sets 315 may be allocated to a UE for a UE mobility procedure.

As illustrated in FIG. 3A, 2 resource sets 315 correspond to each linked cell. Each resource set 315 may be associated with a set of transmission beams for reference signals corresponding to a respective CMR set 320. For example, the candidate cell 305-a may transmit reference signals (e.g., for measurement by a UE) corresponding to a CMR set 320-a over a resource set 315-a and may transmit reference signals corresponding to a CMR set 320-b over a resource set 315-b. Similarly, the second cell 310-a may transmit reference signals corresponding to a CMR set 320-c over a resource set 315-c and may transmit reference signals corresponding to a CMR set 320-d over a resource set 315-d. That is, the CMR set 320-a and the CMR set 320-b (e.g., a first CMR set 320 pair) may correspond to the candidate cell 305-a, while the CMR set 320-c and the CMR set 320-d (e.g., a second CMR set 320 pair) may correspond to the second cell 310-a.

In some cases, a group-based measurement report may include multiple reference signal (e.g., beam) pairs (e.g., groups). The different reference signal pairs may correspond to different linked cells (e.g., the candidate cell 305-a and the second cell 310-a). For example, the group-based measurement report may include a first reference signal (e.g., CMR) and corresponding measurement (e.g., RSRP) from the resource set 315-a, a second reference signal and corresponding measurement from the resource set 315-b, a third reference signal and corresponding measurement from the resource set 315-c, and a fourth reference signal and corresponding measurement from the resource set 315-d.

In some cases, each reference signal pair included in the group-based measurement report may correspond to the same cell while different pairs in the same report may correspond to different respective cells. That is, the group-based measurement report may correspond to multiple CMR set 320 pairs. In some instances, the group-based measurement report may include a cell ID for each reported reference signal pair.

In some cases, a UE or a cell may define a priority rule for the group-based measurement report based on the respective cell ID corresponding to each of the linked cells (e.g., candidate cell 305-a and the second cell 310-a). The smallest cell ID may have a higher priority. In some instances, a specific report (e.g., the group-based measurement report) may not include the reference signal pair from the linked cell with the smallest cell ID.

In some cases, the candidate cell 305-a may correspond to a same frequency or a same intra-frequency measurement as the second cell 310-a. Alternatively, the candidate cell 305-a may correspond to a different frequency or a different intra-frequency measurement as the second cell 310-a. In some instances, inter-frequency measurements for linked cells (e.g., one or more candidate cells 305) from different frequencies may have a different measurement gap.

In some cases, the group-based measurement report may include reference signals in the same reference signal (e.g., beam) pair from different cells. That is, each reference signal in a reference signal pair may correspond to a different cell or PCI. As illustrated in FIG. 3B, each resource set 315 may correspond to a different cell. That is, each resource set 315 may be associated with a set of transmission beams for reference signals corresponding to a respective CMR set 320. For example, a candidate cell 305-b may transmit reference signals (e.g., for measurement by a UE) corresponding to a CMR set 320-e over a resource set 315-e. Similarly, the second cell 310-b may transmit reference signals corresponding to a CMR set 320-f over a resource set 315-f. Thus, the CMR set 320-e and the CMR set 320-f (e.g., a CMR set 320 pair) may correspond to both the candidate cell 305-b and the second cell 310-b (e.g., different cells), respectively.

In some cases, a CMR set 320 may contain reference signals corresponding to different cells. For example, a CMR set 320 may include reference signals from both the candidate cell 305-b and the second cell 310-b. In these cases, a UE may transmit an indication of a CMR from the candidate cell 305-b or the second cell 310-b. In some instances, a group-based measurement report may include reference signal identifiers (RS ID) within each CMR set 320. Additionally, or alternatively, the group-based measurement report may include a RSRP value corresponding to each reference signal.

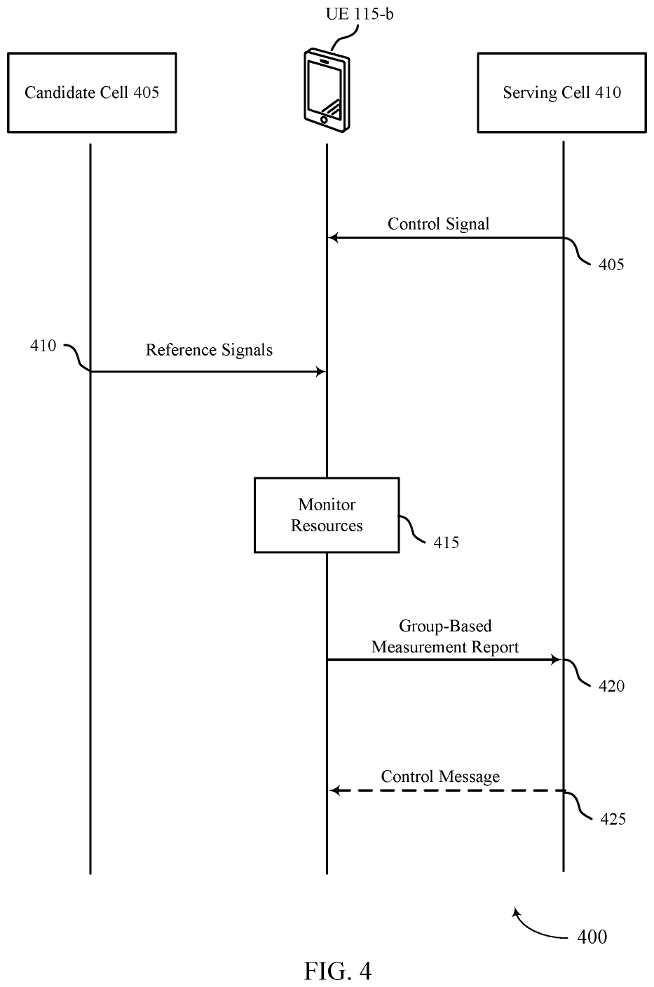

FIG. 4 shows an example of a process flow 400 that supports group based beam report enhancement for LTM in accordance with one or more aspects of the present disclosure. The process flow 400 may implement or be implanted to facilitate or realize aspects of the wireless communications system 100, the wireless communications system 200, and the wireless communications system 300 described with reference to FIGS. 1 through 3. For example, the process flow 400 illustrates communications between a candidate cell 405, a UE 115-b, and a serving cell 410, which may be examples of corresponding devices as illustrated by and described with reference to FIGS. 1 through 3. In some implementations, the candidate cell 405 and the serving cell 410 may be associated with (e.g., a component of or controlled by) a network entity 105. The process flow 400 may be implemented by the candidate cell 405, the UE 115-b, and the serving cell 410 to reduce latency during a cell switch (e.g., mobility or handover procedure) and lower signaling overhead.

In the following description of the process flow 400, the operations between the candidate cell 405, the UE 115-b, and the serving cell 410 may be transmitted in a different order than the example order shown, or the operations performed by the candidate cell 405, the UE 115-b, and the serving cell 410 may be performed in different orders or at different times. Some operations may also be omitted from the process flow 400, and other operations may be added to the process flow 400. Further, although some operations or signaling may be shown to occur at different times for discussion purposes, these operations may actually occur at the same time.

At 405, the serving cell 410 may transmit a control signal indicating a first resource set and a second resource set to the UE 115-b. The control signal may be an example of the control signal 215 with respect to FIG. 2. In some aspects, the serving cell 410 may allocate the first resource set and the second resource set to the UE 115-b for group-based channel measurement reporting for a UE mobility procedure by the UE 115-b. Additionally, the serving cell 410 may indicate that the first resource set and the second resource set may be associated with the candidate cell 405.

At 410, the candidate cell 405 may transmit reference signals to the UE 115-b. For example, the candidate cell 405 may transmit the reference signals using resources of the first and second resource sets. In some instances, the reference signals may include a first subset of reference signals (e.g., a first reference signal) associated with the first resource set and a second subset of reference signals (e.g., a second reference signal) associated with the second resource set. Additionally, the first resource set may correspond to a first CMR set and the second resource set may correspond to a second CMR set. The candidate cell 405 may transmit the first subset of reference signals and the second subset of reference signals at the same time (e.g., via one or more time resources that at least partially overlap in time).

At 415, the UE 115-b may monitor the first and second resource sets. For example, the UE 115-b may monitor the first and second resource sets for reference signals from the candidate cell 405. In some instances, the UE 115-b may measure the reference signals for their respective RSRP values.

At 420, the UE 115-b may transmit a group-based measurement report to the serving cell 410. The group-based measurement report may be an example of the group-based measurement report 225 with respect to FIG. 2. In some cases, the group-based measurement report may be associated with at least the candidate cell 405. For example, the group-based measurement report may indicate measurements (e.g., RSRP values) associated with reference signals from the candidate cell 405. In some examples, the group-based measurement report report may also indicate which transmit beams are associated with the measured reference signals (e.g., different transmit beams may correspond to different resources within a given CMR set).

At 425, the serving cell 410 may transmit a control message to the UE 115-b. For example, the control message may indicate the UE 115-b to switch its coverage from the serving cell 410 to the candidate cell 405 in a UE mobility procedure (e.g., handover procedure).

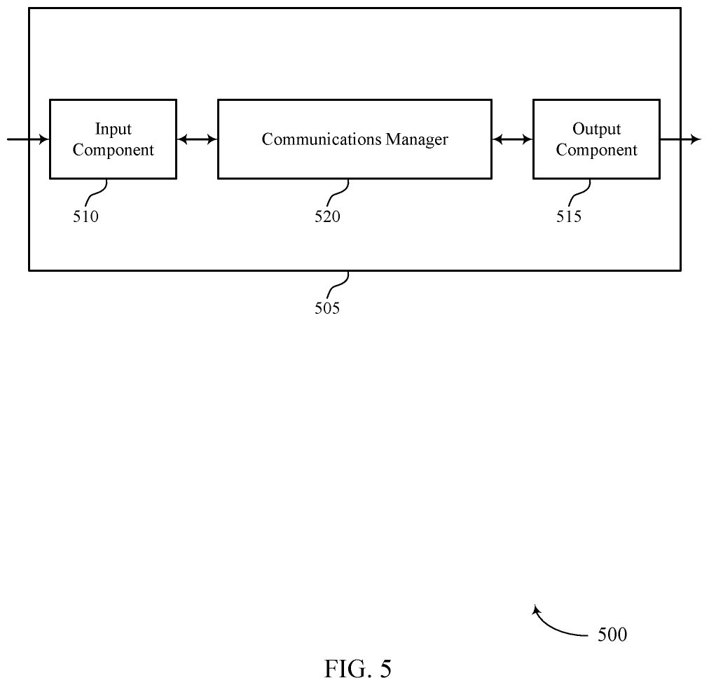

FIG. 5 shows a block diagram 500 of a device 505 that supports group based beam report enhancement for LTM in accordance with one or more aspects of the present disclosure. The device 505 may be an example of aspects of a UE 115 as described herein. The device 505 may include an input component 510, an output component 515, and a communications manager 520. The device 505 may also include a processor. Each of these components may be in communication with one another (e.g., via one or more buses).

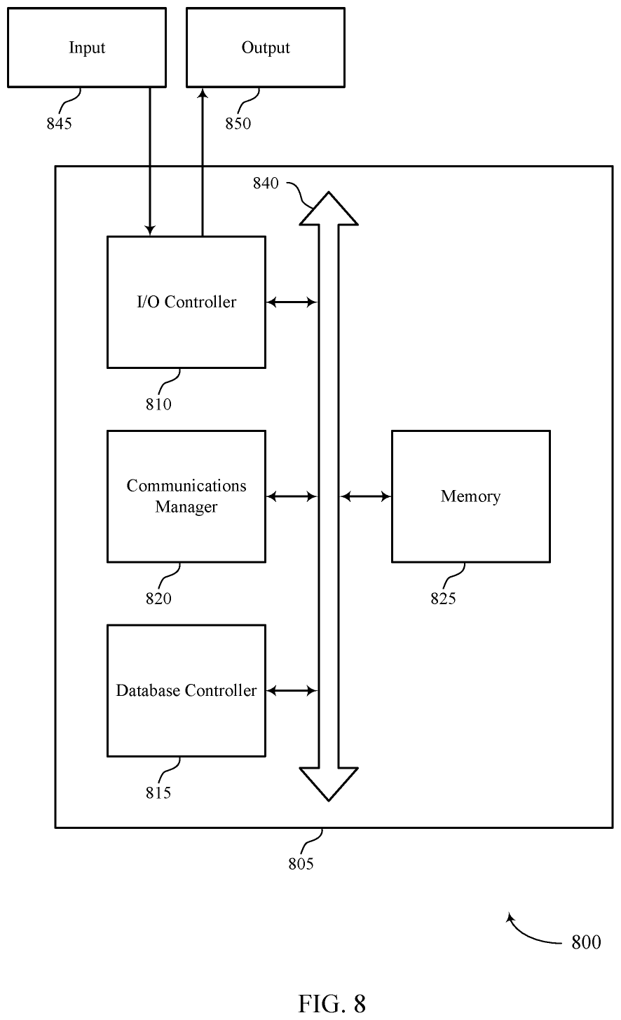

The input component 510 may manage input signals for the apparatus 505. For example, the input component 510 may identify input signals based on an interaction with a modem, a keyboard, a mouse, a touchscreen, or a similar device. These input signals may be associated with user input or processing at other components or devices. In some cases, the input component 510 may utilize an operating system such as iOSR, ANDROIDR, MS-DOSR, MS-WINDOWS®, OS/2R, UNIXR, LINUXR, or another known operating system to handle input signals. The input component 510 may send aspects of these input signals to other components of the apparatus 505 for processing. For example, the input component 510 may transmit input signals to the communications manager 520 to support group based beam report enhancement for LTM. In some cases, the input component 510 may be a component of an input/output (I/O) controller 810 as described with reference to FIG. 8.

The output component 515 may manage output signals for the apparatus 505. For example, the output component 515 may receive signals from other components of the apparatus 505, such as the communications manager 520, and may transmit these signals to other components or devices. In some specific examples, the output component 515 may transmit output signals for display in a user interface, for storage in a database or data store, for further processing at a server or server cluster, or for any other processes at any number of devices or systems. In some cases, the output component 515 may be a component of an I/O controller 810 as described with reference to FIG. 8.

The communications manager 520, the input component 510, the output component 515, or various combinations thereof or various components thereof may be examples of means for performing various aspects of group based beam report enhancement for LTM as described herein. For example, the communications manager 520, the input component 510, the output component 515, or various combinations or components thereof may support a method for performing one or more of the functions described herein.

In some examples, the communications manager 520, the input component 510, the output component 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the input component 510, the output component 515, or various combinations or components thereof may be implemented in code (e.g., as communications management software or firmware) executed by a processor. If implemented in code executed by a processor, the functions of the communications manager 520, the input component 510, the output component 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the input component 510, the output component 515, or both. For example, the communications manager 520 may receive information from the input component 510, send information to the output component 515, or be integrated in combination with the input component 510, the output component 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving a control signal indicating a first resource set and a second resource set that are allocated to the UE for group-based channel measurement reporting for a UE mobility procedure, where both the first resource set and the second resource set are associated with a candidate cell for the UE mobility procedure. The communications manager 520 is capable of, configured to, or operable to support a means for monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The communications manager 520 is capable of, configured to, or operable to support a means for transmitting a group-based measurement report for the candidate cell, the group-based measurement report indicating one or more measurements of the set of multiple reference signals associated with the candidate cell based on monitoring the first and second resource sets.

Additionally, or alternatively, the communications manager 520 may support wireless communications at a UE in accordance with examples as disclosed herein. For example, the communications manager 520 is capable of, configured to, or operable to support a means for receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure. The communications manager 520 is capable of, configured to, or operable to support a means for monitoring the first resource set for a first set of multiple reference signals associated with the candidate cell in accordance with the UE mobility procedure and the second resource set for a second set of multiple reference signals associated with the second cell in accordance with the UE mobility procedure. The communications manager 520 is capable of, configured to, or operable to support a means for transmitting a group-based measurement report indicating one or more measurements of the first set of multiple reference signals associated with the candidate cell and one or more measurements of the second set of multiple reference signals associated with the second cell based on monitoring the first and second resource sets.

By including or configuring the communications manager 520 in accordance with examples as described herein, the device 505 (e.g., a processor controlling or otherwise coupled with the input component 510, the output component 515, the communications manager 520, or a combination thereof) may support techniques for reducing a latency associated with a cell switch by enabling the device 505 to obtain measurements for multiple candidate cell resource sets, which may be used for handover or cell switch.

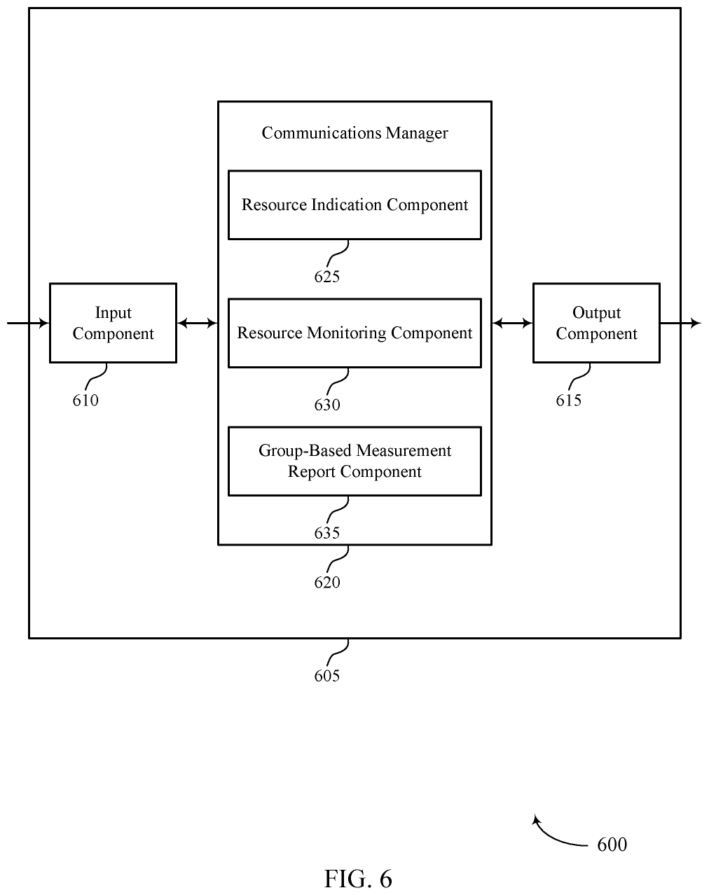

FIG. 6 shows a block diagram 600 of a device 605 that supports group based beam report enhancement for LTM in accordance with one or more aspects of the present disclosure. The device 605 may be an example of aspects of a device 505 or a UE 115 as described herein. The device 605 may include an input component 610, an output component 615, and a communications manager 620. The device 605 may also include a processor. Each of these components may be in communication with one another (e.g., via one or more buses).

The input component 610 may manage input signals for the apparatus 605. For example, the input component 610 may identify input signals based on an interaction with a modem, a keyboard, a mouse, a touchscreen, or a similar device. These input signals may be associated with user input or processing at other components or devices. In some cases, the input component 610 may utilize an operating system such as iOSR, ANDROIDR, MS-DOSR, MS-WINDOWS®, OS/2R, UNIXR, LINUXR, or another known operating system to handle input signals. The input component 610 may send aspects of these input signals to other components of the apparatus 605 for processing. For example, the input component 610 may transmit input signals to the communications manager 620 to support group based beam report enhancement for LTM. In some cases, the input component 610 may be a component of an I/O controller 810 as described with reference to FIG. 8.

The output component 615 may manage output signals for the apparatus 605. For example, the output component 615 may receive signals from other components of the apparatus 605, such as the communications manager 620, and may transmit these signals to other components or devices. In some specific examples, the output component 615 may transmit output signals for display in a user interface, for storage in a database or data store, for further processing at a server or server cluster, or for any other processes at any number of devices or systems. In some cases, the output component 615 may be a component of an I/O controller 810 as described with reference to FIG. 8.

The device 605, or various components thereof, may be an example of means for performing various aspects of group based beam report enhancement for LTM as described herein. For example, the communications manager 620 may include a resource indication component 625, a resource monitoring component 630, a group-based measurement report component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the input component 610, the output component 615, or both. For example, the communications manager 620 may receive information from the input component 610, send information to the output component 615, or be integrated in combination with the input component 610, the output component 615, or both to obtain information, output information, or perform various other operations as described herein.

The communications manager 620 may support wireless communications at a UE in accordance with examples as disclosed herein. The resource indication component 625 is capable of, configured to, or operable to support a means for receiving a control signal indicating a first resource set and a second resource set that are allocated to the UE for group-based channel measurement reporting for a UE mobility procedure, where both the first resource set and the second resource set are associated with a candidate cell for the UE mobility procedure. The resource monitoring component 630 is capable of, configured to, or operable to support a means for monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The group-based measurement report component 635 is capable of, configured to, or operable to support a means for transmitting a group-based measurement report for the candidate cell, the group-based measurement report indicating one or more measurements of the set of multiple reference signals associated with the candidate cell based on monitoring the first and second resource sets.

Additionally, or alternatively, the communications manager 620 may support wireless communications at a UE in accordance with examples as disclosed herein. The resource indication component 625 is capable of, configured to, or operable to support a means for receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure. The resource monitoring component 630 is capable of, configured to, or operable to support a means for monitoring the first resource set for a first set of multiple reference signals associated with the candidate cell in accordance with the UE mobility procedure and the second resource set for a second set of multiple reference signals associated with the second cell in accordance with the UE mobility procedure. The group-based measurement report component 635 is capable of, configured to, or operable to support a means for transmitting a group-based measurement report indicating one or more measurements of the first set of multiple reference signals associated with the candidate cell and one or more measurements of the second set of multiple reference signals associated with the second cell based on monitoring the first and second resource sets.

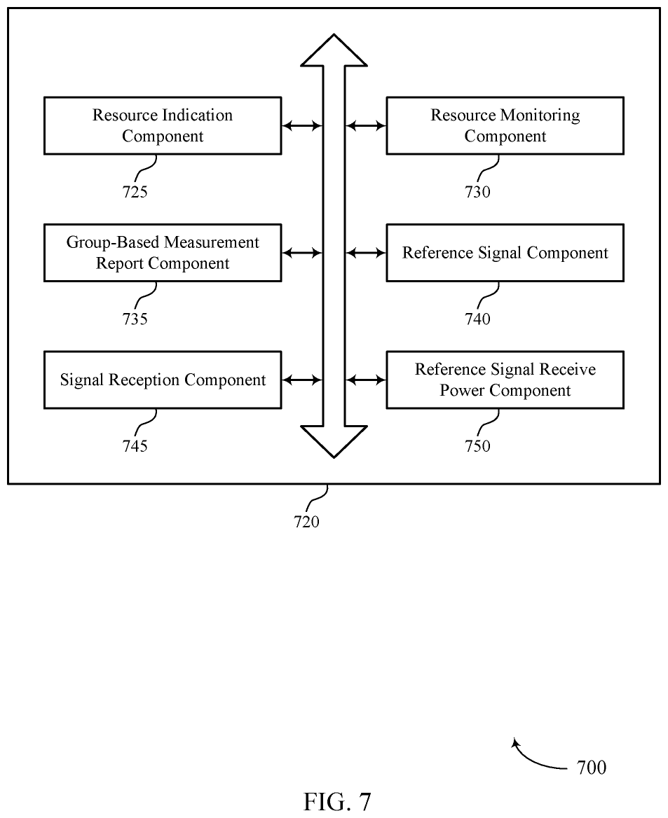

FIG. 7 shows a block diagram 700 of a communications manager 720 that supports group based beam report enhancement for LTM in accordance with one or more aspects of the present disclosure. The communications manager 720 may be an example of aspects of a communications manager 520, a communications manager 620, or both, as described herein. The communications manager 720, or various components thereof, may be an example of means for performing various aspects of group based beam report enhancement for LTM as described herein. For example, the communications manager 720 may include a resource indication component 725, a resource monitoring component 730, a group-based measurement report component 735, a reference signal component 740, a signal reception component 745, a reference signal receive power component 750, or any combination thereof. Each of these components may communicate, directly or indirectly, with one another (e.g., via one or more buses).

The communications manager 720 may support wireless communications at a UE in accordance with examples as disclosed herein. The resource indication component 725 is capable of, configured to, or operable to support a means for receiving a control signal indicating a first resource set and a second resource set that are allocated to the UE for group-based channel measurement reporting for a UE mobility procedure, where both the first resource set and the second resource set are associated with a candidate cell for the UE mobility procedure. The resource monitoring component 730 is capable of, configured to, or operable to support a means for monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The group-based measurement report component 735 is capable of, configured to, or operable to support a means for transmitting a group-based measurement report for the candidate cell, the group-based measurement report indicating one or more measurements of the set of multiple reference signals associated with the candidate cell based on monitoring the first and second resource sets.

In some examples, the reference signal component 740 is capable of, configured to, or operable to support a means for receiving a first reference signal of the first subset of reference signals via one or more time resources of the first resource set based on the monitoring. In some examples, the reference signal component 740 is capable of, configured to, or operable to support a means for receiving a second reference signal of the second subset of reference signals via one or more time resources of the second resource set that at least partially overlap in time with the one or more time resources of the first resource set based on the monitoring.

In some examples, to support transmitting the group-based measurement report, the reference signal receive power component 750 is capable of, configured to, or operable to support a means for transmitting a first reference signal receive power value associated with the first reference signal based on the monitoring. In some examples, to support transmitting the group-based measurement report, the reference signal receive power component 750 is capable of, configured to, or operable to support a means for transmitting a second reference signal receive power value associated with the second reference signal based on the monitoring.

In some examples, to support transmitting the group-based measurement report, the group-based measurement report component 735 is capable of, configured to, or operable to support a means for transmitting the group-based measurement report based on a priority rule for group-based channel measurement reporting.

In some examples, to support transmitting the group-based measurement report, the group-based measurement report component 735 is capable of, configured to, or operable to support a means for transmitting the group-based measurement report via the time resources based on the first cell identifier being smaller than the second cell identifier in accordance with the priority rule.

In some examples, to support receiving the control signal, the resource indication component 725 is capable of, configured to, or operable to support a means for receiving the control signal indicating a first cell identifier associated with the candidate cell.

In some examples, to support receiving the control signal, the signal reception component 745 is capable of, configured to, or operable to support a means for receiving the control signal via a field in a radio resource control message.

In some examples, to support receiving the control signal, the signal reception component 745 is capable of, configured to, or operable to support a means for receiving the control signal indicating a channel state information reference signal associated with the candidate cell.

In some examples, a configuration corresponding to the channel state information reference signal indicates that the first resource set and the second resource set are associated with the candidate cell.

In some examples, to support receiving the control signal, the signal reception component 745 is capable of, configured to, or operable to support a means for receiving the control signal via a serving cell.

In some examples, the resource indication component 725 is capable of, configured to, or operable to support a means for receiving the control signal indicating a third resource set and a fourth resource set that are allocated to the UE for group-based channel measurement reporting for the UE mobility procedure, where both the third resource set and the fourth resource set are associated with a second cell for the UE mobility procedure. In some examples, the resource monitoring component 730 is capable of, configured to, or operable to support a means for monitoring the third and fourth resource sets for a second set of multiple reference signals associated with the second cell in accordance with the UE mobility procedure, the second set of multiple reference signals including a third subset of reference signals associated with the third resource set and a fourth subset of reference signals associated with the fourth resource set. In some examples, the group-based measurement report component 735 is capable of, configured to, or operable to support a means for transmitting the group-based measurement report for the second cell, the group-based measurement report indicating one or more measurements of the second set of multiple reference signals associated with the second cell based on monitoring the third and fourth resource sets.

In some examples, the reference signal component 740 is capable of, configured to, or operable to support a means for receiving a first reference signal pair associated with the set of multiple reference signals via one or more time resources of the first and second resource sets based on the monitoring. In some examples, the reference signal component 740 is capable of, configured to, or operable to support a means for receiving a second reference signal pair associated with the second set of multiple reference signals via one or more time resources of the third and fourth resource sets that at least partially overlap in time with the one or more time resources of the first and second resource sets, where the UE is capable of receiving each reference signal of the first reference signal pair and each reference signal of the second reference signal pair over the one or more overlapping time resources based on the monitoring.

In some examples, the second cell is associated with a second candidate cell or a serving cell.

In some examples, the candidate cell and the second cell are associated with a same frequency or a same intra-frequency measurement as a serving cell.

In some examples, the candidate cell and the second cell are associated with a different frequency or a different intra-frequency measurement as a serving cell.

In some examples, the third resource set is associated with a first set of transmission beams for the third subset of reference signals and the fourth resource set is associated with a second set of transmission beams for the fourth subset of reference signals.

In some examples, the third resource set is associated with a first channel measurement resource set and the fourth resource set is associated with a second channel measurement resource set.

In some examples, the first resource set is associated with a first set of transmission beams for the first subset of reference signals and the second resource set is associated with a second set of transmission beams for the second subset of reference signals.

In some examples, the first resource set includes a first channel measurement resource set or a first interference measurement resource set and the second resource set includes a second channel measurement resource set or a second interference measurement resource set.

In some examples, to support receiving the control signal, the signal reception component 745 is capable of, configured to, or operable to support a means for receiving the control signal via a layer 1 (L1) message or a layer 2 (L2) message, where the UE mobility procedure includes an L1/L2 triggered mobility (LTM) procedure.

In some examples, to support receiving the control signal, the signal reception component 745 is capable of, configured to, or operable to support a means for receiving the control signal via the layer 1 message, the layer 1 message including a downlink control information. In some examples, to support receiving the control signal, the signal reception component 745 is capable of, configured to, or operable to support a means for receiving the control signal via the layer 2 message, the layer 2 message including a medium access control (MAC) control element (MAC-CE).

In some examples, the candidate cell is associated with a deactivated serving cell or a non-serving cell.

Additionally, or alternatively, the communications manager 720 may support wireless communications at a UE in accordance with examples as disclosed herein. In some examples, the resource indication component 725 is capable of, configured to, or operable to support a means for receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure. In some examples, the resource monitoring component 730 is capable of, configured to, or operable to support a means for monitoring the first resource set for a first set of multiple reference signals associated with the candidate cell in accordance with the UE mobility procedure and the second resource set for a second set of multiple reference signals associated with the second cell in accordance with the UE mobility procedure. In some examples, the group-based measurement report component 735 is capable of, configured to, or operable to support a means for transmitting a group-based measurement report indicating one or more measurements of the first set of multiple reference signals associated with the candidate cell and one or more measurements of the second set of multiple reference signals associated with the second cell based on monitoring the first and second resource sets.

In some examples, the first and second resource sets are each associated with multiple cells.

In some examples, to support transmitting the group-based measurement report, the reference signal component 740 is capable of, configured to, or operable to support a means for transmitting one or more reference signal identifiers associated with the first set of multiple reference signals and one or more reference signal identifiers associated with the second set of multiple reference signals. In some examples, to support transmitting the group-based measurement report, the reference signal receive power component 750 is capable of, configured to, or operable to support a means for transmitting one or more reference signal receive power values associated with the first set of multiple reference signals and one or more reference signal receive power values associated with the second set of multiple reference signals.

In some examples, the first set of multiple reference signals is associated with a first set of transmission beams and the second set of multiple reference signals is associated with a second set of transmission beams.

FIG. 8 shows a diagram of a system 800 including a device 805 that supports group based beam report enhancement for LTM in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOSR, ANDROIDR, MS-DOSR, MS-WINDOWS®, OS/2R, UNIXR, LINUXR, or another known operating system. Additionally or alternatively, the I/O controller 810 may represent or interact with a modem, a keyboard, a mouse, a touchscreen, or a similar device. In some cases, the I/O controller 810 may be implemented as part of a processor. In some examples, a user may interact with the device 805 via the I/O controller 810 or via hardware components controlled by the I/O controller 810.

The database controller 815 may manage data storage and processing in a database 835. The database 835 may be external to the device 805, temporarily or permanently connected to the device 805, or a data storage component of the device 805. In some cases, a user may interact with the database controller 815. In some other cases, the database controller 815 may operate automatically without user interaction. The database 835 may be an example of a persistent data store, a single database, a distributed database, multiple distributed databases, a database management system, or an emergency backup database.

Memory 825 may include random-access memory (RAM) and read-only memory (ROM). The memory 825 may store computer-readable, computer-executable software including instructions that, when executed, cause the processor to perform various functions described herein. In some cases, the memory 825 may contain, among other things, a basic I/O system (BIOS) which may control basic hardware or software operation such as the interaction with peripheral components or devices.

The processor 830 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In some other cases, a memory controller may be integrated into the processor 830. The processor 830 may be configured to execute computer-readable instructions stored in memory 825 to perform various functions (e.g., functions or tasks supporting group based beam report enhancement for LTM).

The communications manager 820 may support wireless communications at a UE in accordance with examples as disclosed herein. For example, the communications manager 820 is capable of, configured to, or operable to support a means for receiving a control signal indicating a first resource set and a second resource set that are allocated to the UE for group-based channel measurement reporting for a UE mobility procedure, where both the first resource set and the second resource set are associated with a candidate cell for the UE mobility procedure. The communications manager 820 is capable of, configured to, or operable to support a means for monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The communications manager 820 is capable of, configured to, or operable to support a means for transmitting a group-based measurement report for the candidate cell, the group-based measurement report indicating one or more measurements of the set of multiple reference signals associated with the candidate cell based on monitoring the first and second resource sets.

Additionally, or alternatively, the communications manager 820 may support wireless communications at a UE in accordance with examples as disclosed herein. For example, the communications manager 820 is capable of, configured to, or operable to support a means for receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure. The communications manager 820 is capable of, configured to, or operable to support a means for monitoring the first resource set for a first set of multiple reference signals associated with the candidate cell in accordance with the UE mobility procedure and the second resource set for a second set of multiple reference signals associated with the second cell in accordance with the UE mobility procedure. The communications manager 820 is capable of, configured to, or operable to support a means for transmitting a group-based measurement report indicating one or more measurements of the first set of multiple reference signals associated with the candidate cell and one or more measurements of the second set of multiple reference signals associated with the second cell based on monitoring the first and second resource sets.

By including or configuring the communications manager 820 in accordance with examples as described herein, the device 805 may support techniques for reduced latency, more efficient utilization of communication resources, improved coordination between devices, and enhanced measurement capabilities for candidate cells, which may be used to improve handover or cell switching.

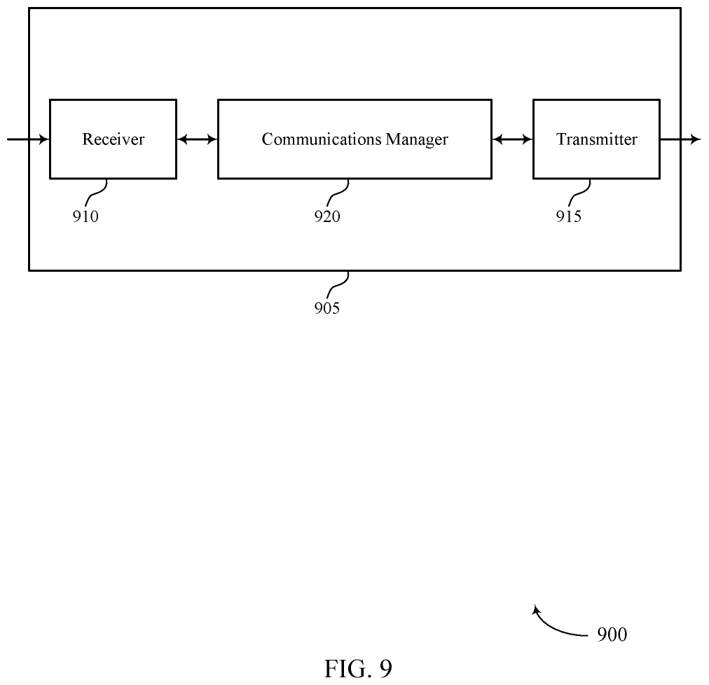

FIG. 9 shows a block diagram 900 of a device 905 that supports group based beam report enhancement for LTM in accordance with one or more aspects of the present disclosure. The device 905 may be an example of aspects of a wireless device as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to group based beam report enhancement for LTM). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to group based beam report enhancement for LTM). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of group based beam report enhancement for LTM as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first wireless device in accordance with examples as disclosed herein. For example, the communications manager 920 is capable of, configured to, or operable to support a means for transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure. The communications manager 920 is capable of, configured to, or operable to support a means for receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

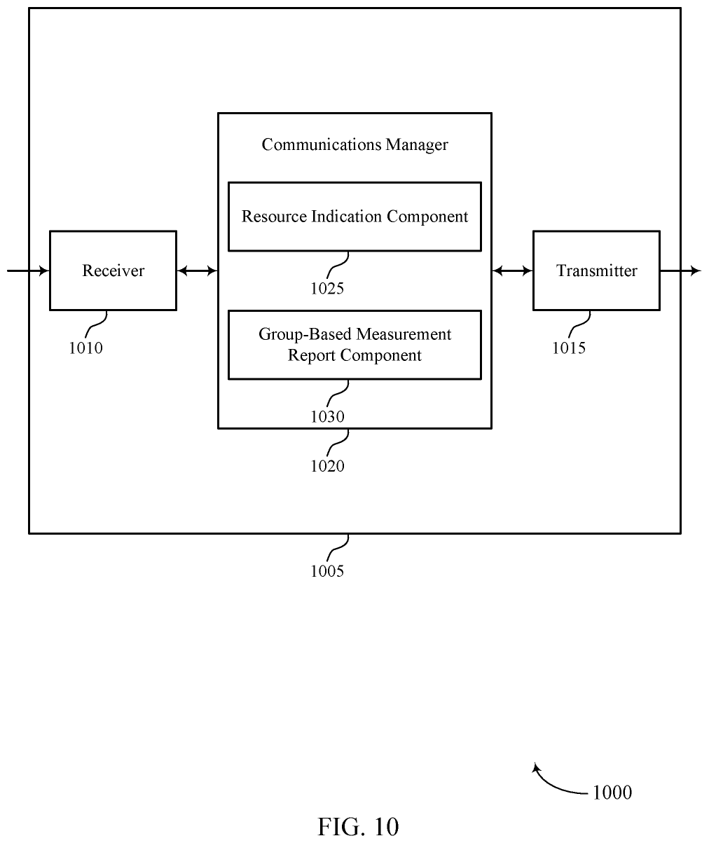

FIG. 10 shows a block diagram 1000 of a device 1005 that supports group based beam report enhancement for LTM in accordance with one or more aspects of the present disclosure. The device 1005 may be an example of aspects of a device 905 or a wireless device 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to group based beam report enhancement for LTM). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to group based beam report enhancement for LTM). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of group based beam report enhancement for LTM as described herein. For example, the communications manager 1020 may include a resource indication component 1025 a group-based measurement report component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first wireless device in accordance with examples as disclosed herein. The resource indication component 1025 is capable of, configured to, or operable to support a means for transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure. The group-based measurement report component 1030 is capable of, configured to, or operable to support a means for receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

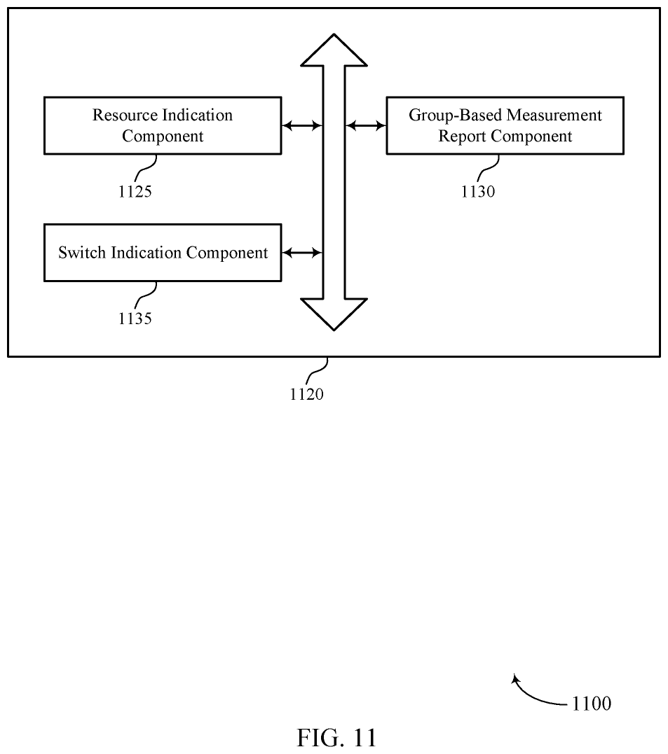

FIG. 11 shows a block diagram 1100 of a communications manager 1120 that supports group based beam report enhancement for LTM in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of group based beam report enhancement for LTM as described herein. For example, the communications manager 1120 may include a resource indication component 1125, a group-based measurement report component 1130, a switch indication component 1135, or any combination thereof. Each of these components may communicate, directly or indirectly, with one another (e.g., via one or more buses).

The communications manager 1120 may support wireless communications at a first wireless device in accordance with examples as disclosed herein. The resource indication component 1125 is capable of, configured to, or operable to support a means for transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure. The group-based measurement report component 1130 is capable of, configured to, or operable to support a means for receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

In some examples, the switch indication component 1135 is capable of, configured to, or operable to support a means for transmitting, to the UE, a control message indicating the UE to switch to the candidate cell.

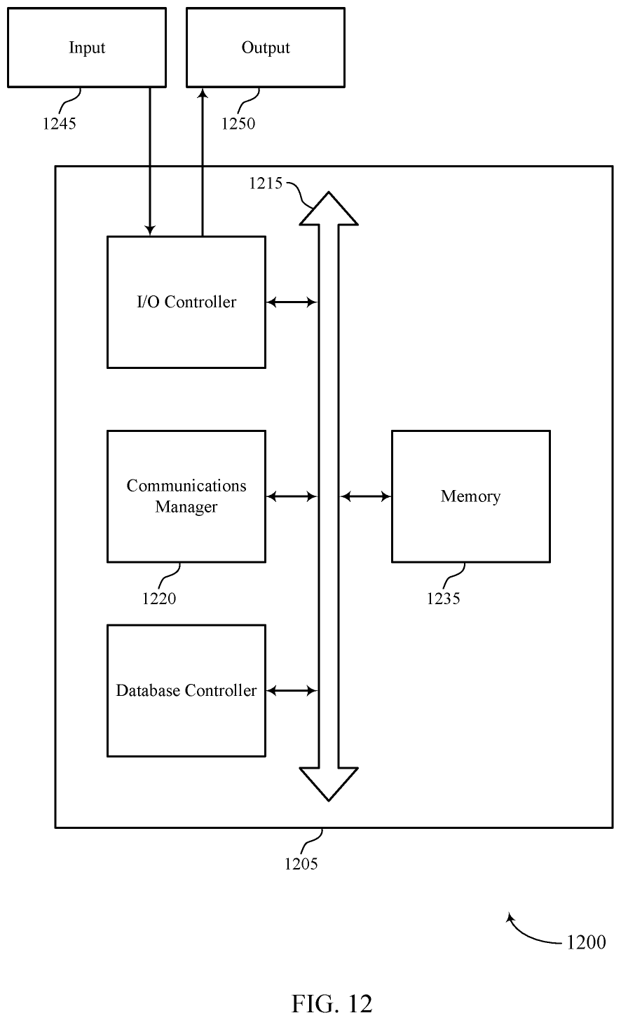

FIG. 12 shows a diagram of a system 1200 including a device 1205 that supports group based beam report enhancement for LTM in accordance with one or more aspects of the present disclosure. The device 1205 may be an example of or include the components of a device 905, a device 1005, or a wireless device as described herein. The device 1205 may include components for bi-directional voice and data communications including components for transmitting and receiving communications, such as a communications manager 1220, an antenna 1210, code 1225, an inter-station communications manager 1230, a memory 1235, a processor 1240, and a transceiver 1245. These components may be in electronic communication or otherwise coupled (e.g., operatively, communicatively, functionally, electronically, electrically) via one or more buses (e.g., a bus 1215).

The inter-station communications manager 1230 may manage communications with other base stations 105, and may include a controller or scheduler for controlling communications with UEs 115 in cooperation with other base stations 105. For example, the inter-station communications manager 1230 may coordinate scheduling for transmissions to UEs 115 for various interference mitigation techniques such as beamforming or joint transmission. In some examples, the inter-station communications manager 1230 may provide an X2 interface within an LTE/LTE-A wireless communications network technology to provide communication between base stations 105.

The memory 1235 may include RAM and ROM. The memory 1235 may store computer-readable, computer-executable code 1225 including instructions that, when executed by the processor 1240, cause the device 1205 to perform various functions described herein. The code 1225 may be stored in a non-transitory computer-readable medium such as system memory or another type of memory. In some cases, the code 1225 may not be directly executable by the processor 1240 but may cause a computer (e.g., when compiled and executed) to perform functions described herein. In some cases, the memory 1235 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1235) to cause the device 1205 to perform various functions (e.g., functions or tasks supporting group based beam report enhancement for LTM). For example, the device 1205 or a component of the device 1205 may include a processor 1240 and memory 1235 coupled with or to the processor 1240, the processor 1240 and memory 1235 configured to perform various functions described herein.

In some cases, the device 1205 may include a single antenna 1210. However, in some other cases, the device 1205 may have more than one antenna 1210, which may be capable of concurrently transmitting or receiving multiple wireless transmissions. The transceiver 1245 may communicate bi-directionally, via the one or more antennas 1210, wired, or wireless links as described herein. For example, the transceiver 1245 may represent a wireless transceiver and may communicate bi-directionally with another wireless transceiver. The transceiver 1245 may also include a modem to modulate the packets, to provide the modulated packets to one or more antennas 1210 for transmission, and to demodulate packets received from the one or more antennas 1210. The transceiver 1245, or the transceiver 1245 and one or more antennas 1210, may be an example of a transmitter 915, a transmitter 1015, a receiver 910, a receiver 1010, or any combination thereof or component thereof, as described herein.

The communications manager 1220 may support wireless communications at a first wireless device in accordance with examples as disclosed herein. For example, the communications manager 1220 is capable of, configured to, or operable to support a means for transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure. The communications manager 1220 is capable of, configured to, or operable to support a means for receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set.

By including or configuring the communications manager 1220 in accordance with examples as described herein, the device 1205 may support techniques for reduced latency, more efficient utilization of communication resources, improved coordination between devices, and enhanced measurement capabilities for handover or cell switching to a candidate cell.

In some examples, the communications manager 1220 may be configured to perform various operations (e.g., receiving, monitoring, transmitting) using or otherwise in cooperation with the transceiver 1245, the one or more antennas 1210, or any combination thereof. Although the communications manager 1220 is illustrated as a separate component, in some examples, one or more functions described with reference to the communications manager 1220 may be supported by or performed by the processor 1240, the memory 1235, the code 1225, or any combination thereof. For example, the code 1225 may include instructions executable by the processor 1240 to cause the device 1205 to perform various aspects of group based beam report enhancement for LTM as described herein, or the processor 1240 and the memory 1235 may be otherwise configured to perform or support such operations.

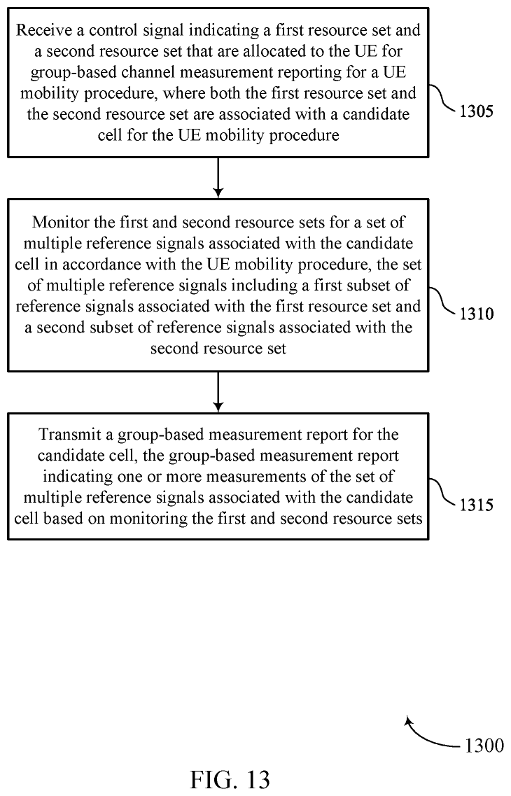

FIG. 13 shows a flowchart illustrating a method 1300 that supports group based beam report enhancement for LTM in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving a control signal indicating a first resource set and a second resource set that are allocated to the UE for group-based channel measurement reporting for a UE mobility procedure, where both the first resource set and the second resource set are associated with a candidate cell for the UE mobility procedure. The operations of 1305 may be performed in accordance with examples as disclosed herein. In some examples, aspects of the operations of 1305 may be performed by a resource indication component 725 as described with reference to FIG. 7.

At 1310, the method may include monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The operations of 1310 may be performed in accordance with examples as disclosed herein. In some examples, aspects of the operations of 1310 may be performed by a resource monitoring component 730 as described with reference to FIG. 7.

At 1315, the method may include transmitting a group-based measurement report for the candidate cell, the group-based measurement report indicating one or more measurements of the set of multiple reference signals associated with the candidate cell based on monitoring the first and second resource sets. The operations of 1315 may be performed in accordance with examples as disclosed herein. In some examples, aspects of the operations of 1315 may be performed by a group-based measurement report component 735 as described with reference to FIG. 7.

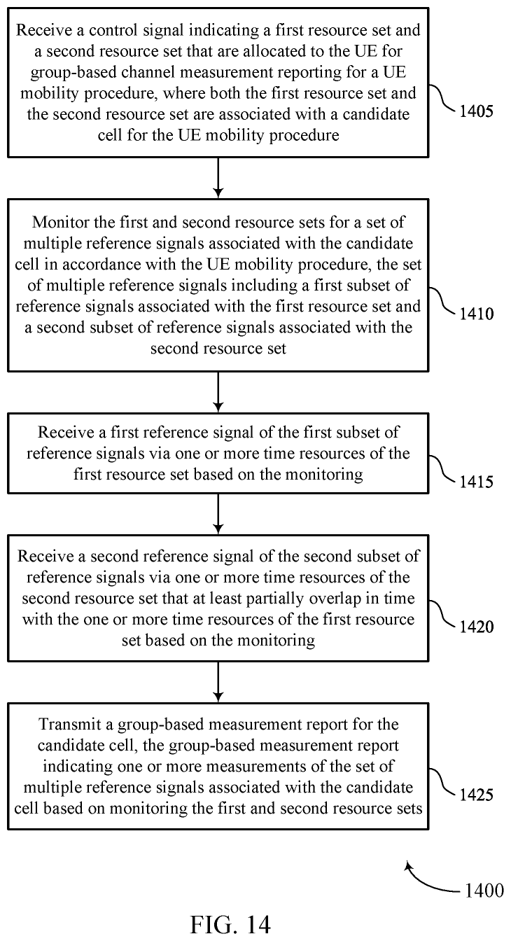

FIG. 14 shows a flowchart illustrating a method 1400 that supports group based beam report enhancement for LTM in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a control signal indicating a first resource set and a second resource set that are allocated to the UE for group-based channel measurement reporting for a UE mobility procedure, where both the first resource set and the second resource set are associated with a candidate cell for the UE mobility procedure. The operations of 1405 may be performed in accordance with examples as disclosed herein. In some examples, aspects of the operations of 1405 may be performed by a resource indication component 725 as described with reference to FIG. 7.

At 1410, the method may include monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The operations of 1410 may be performed in accordance with examples as disclosed herein. In some examples, aspects of the operations of 1410 may be performed by a resource monitoring component 730 as described with reference to FIG. 7.

At 1415, the method may include receiving a first reference signal of the first subset of reference signals via one or more time resources of the first resource set based on the monitoring. The operations of 1415 may be performed in accordance with examples as disclosed herein. In some examples, aspects of the operations of 1415 may be performed by a reference signal component 740 as described with reference to FIG. 7.

At 1420, the method may include receiving a second reference signal of the second subset of reference signals via one or more time resources of the second resource set that at least partially overlap in time with the one or more time resources of the first resource set based on the monitoring. The operations of 1420 may be performed in accordance with examples as disclosed herein. In some examples, aspects of the operations of 1420 may be performed by a reference signal component 740 as described with reference to FIG. 7.

At 1425, the method may include transmitting a group-based measurement report for the candidate cell, the group-based measurement report indicating one or more measurements of the set of multiple reference signals associated with the candidate cell based on monitoring the first and second resource sets. The operations of 1425 may be performed in accordance with examples as disclosed herein. In some examples, aspects of the operations of 1425 may be performed by a group-based measurement report component 735 as described with reference to FIG. 7.

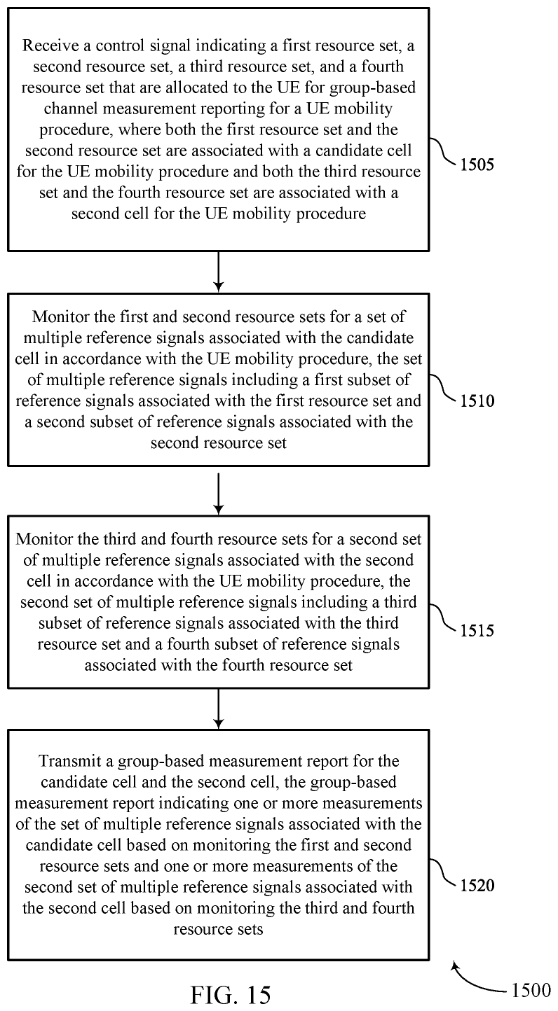

FIG. 15 shows a flowchart illustrating a method 1500 that supports group based beam report enhancement for LTM in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a control signal indicating a first resource set, a second resource set, a third resource set, and a fourth resource set that are allocated to the UE for group-based channel measurement reporting for a UE mobility procedure, where both the first resource set and the second resource set are associated with a candidate cell for the UE mobility procedure and both the third resource set and the fourth resource set are associated with a second cell for the UE mobility procedure. The operations of 1505 may be performed in accordance with examples as disclosed herein. In some examples, aspects of the operations of 1505 may be performed by a resource indication component 725 as described with reference to FIG. 7.

At 1510, the method may include monitoring the first and second resource sets for a set of multiple reference signals associated with the candidate cell in accordance with the UE mobility procedure, the set of multiple reference signals including a first subset of reference signals associated with the first resource set and a second subset of reference signals associated with the second resource set. The operations of 1510 may be performed in accordance with examples as disclosed herein. In some examples, aspects of the operations of 1510 may be performed by a resource monitoring component 730 as described with reference to FIG. 7.

At 1515, the method may include monitoring the third and fourth resource sets for a second set of multiple reference signals associated with the second cell in accordance with the UE mobility procedure, the second set of multiple reference signals including a third subset of reference signals associated with the third resource set and a fourth subset of reference signals associated with the fourth resource set. The operations of 1515 may be performed in accordance with examples as disclosed herein. In some examples, aspects of the operations of 1515 may be performed by a resource monitoring component 730 as described with reference to FIG. 7.

At 1520, the method may include transmitting a group-based measurement report for the candidate cell and the second cell, the group-based measurement report indicating one or more measurements of the set of multiple reference signals associated with the candidate cell based on monitoring the first and second resource sets and one or more measurements of the second set of multiple reference signals associated with the second cell based on monitoring the third and fourth resource sets. The operations of 1520 may be performed in accordance with examples as disclosed herein. In some examples, aspects of the operations of 1520 may be performed by a group-based measurement report component 735 as described with reference to FIG. 7.

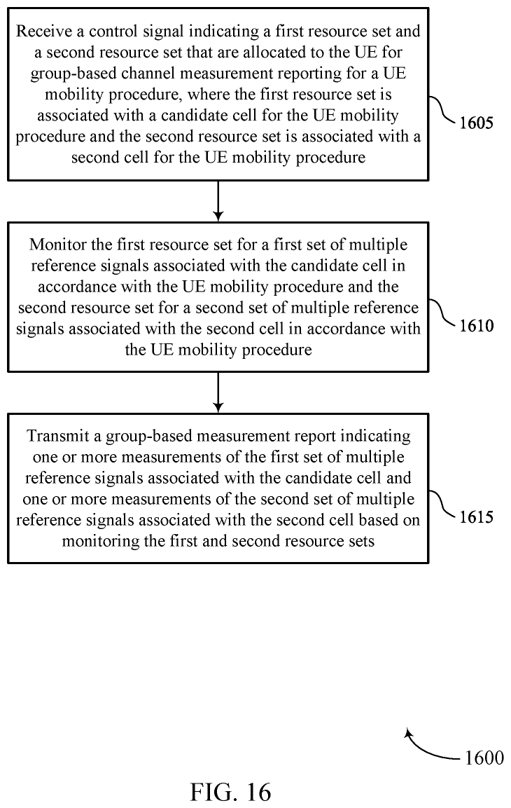

FIG. 16 shows a flowchart illustrating a method 1600 that supports group based beam report enhancement for LTM in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving a control signal indicating a first resource set and a second resource set that are allocated to the UE for group-based channel measurement reporting for a UE mobility procedure, where the first resource set is associated with a candidate cell for the UE mobility procedure and the second resource set is associated with a second cell for the UE mobility procedure. The operations of 1605 may be performed in accordance with examples as disclosed herein. In some examples, aspects of the operations of 1605 may be performed by a resource indication component 725 as described with reference to FIG. 7.

At 1610, the method may include monitoring the first resource set for a first set of multiple reference signals associated with the candidate cell in accordance with the UE mobility procedure and the second resource set for a second set of multiple reference signals associated with the second cell in accordance with the UE mobility procedure. The operations of 1610 may be performed in accordance with examples as disclosed herein. In some examples, aspects of the operations of 1610 may be performed by a resource monitoring component 730 as described with reference to FIG. 7.

At 1615, the method may include transmitting a group-based measurement report indicating one or more measurements of the first set of multiple reference signals associated with the candidate cell and one or more measurements of the second set of multiple reference signals associated with the second cell based on monitoring the first and second resource sets. The operations of 1615 may be performed in accordance with examples as disclosed herein. In some examples, aspects of the operations of 1615 may be performed by a group-based measurement report component 735 as described with reference to FIG. 7.

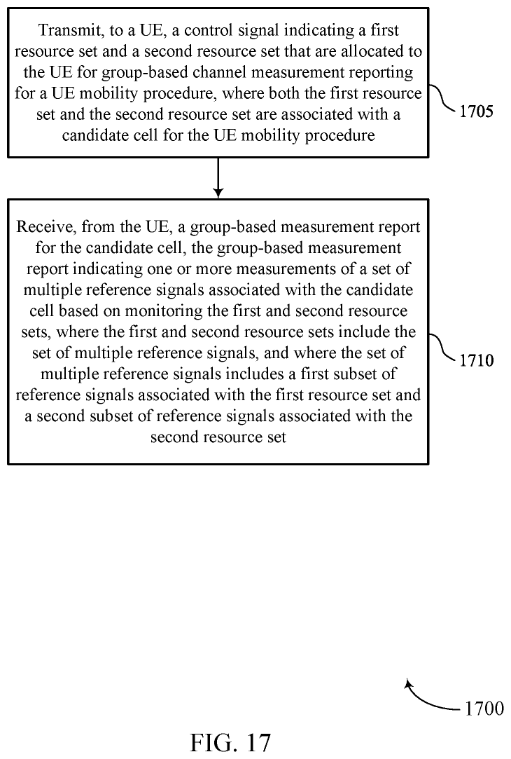

FIG. 17 shows a flowchart illustrating a method 1700 that supports group based beam report enhancement for LTM in accordance with aspects of the present disclosure. The operations of the method 1700 may be implemented by a wireless device or its components as described herein. For example, the operations of the method 1700 may be performed by a wireless device as described with reference to FIGS. 1 through 4 and 9 through 12. In some examples, a wireless device may execute a set of instructions to control the functional elements of the wireless wireless device to perform the described functions. Additionally, or alternatively, the wireless wireless device may perform aspects of the described functions using special-purpose hardware.

At 1705, the method may include transmitting, to a UE, a control signal indicating a first resource set and a second resource set that are allocated to the UE for group-based channel measurement reporting for a UE mobility procedure, where both the first resource set and the second resource set are associated with a candidate cell for the UE mobility procedure. The operations of 1705 may be performed in accordance with examples as disclosed herein. In some examples, aspects of the operations of 1705 may be performed by a resource indication component 1125 as described with reference to FIG. 11.

At 1710, the method may include receiving, from the UE, a group-based measurement report for the candidate cell, the group-based measurement report indicating one or more measurements of a set of multiple reference signals associated with the candidate cell based on monitoring the first and second resource sets, where the first and second resource sets include the set of multiple reference signals, and where the set of multiple reference signals includes a first subset of reference signals associated with the first resource set and a second subset of reference signals associated with the second resource set. The operations of 1710 may be performed in accordance with examples as disclosed herein. In some examples, aspects of the operations of 1710 may be performed by a group-based measurement report component 1130 as described with reference to FIG. 11.

### SUMMARY OF ASPECTS

The following provides an overview of aspects of the present disclosure:

Aspect 1: A method for wireless communications at a user equipment (UE), comprising: receiving a control signal indicating a first resource set and a second resource set that are allocated to the UE for group-based channel measurement reporting for a UE mobility procedure, wherein both the first resource set and the second resource set are associated with a candidate cell for the UE mobility procedure: monitoring the first and second resource sets for a plurality of reference signals associated with the candidate cell in accordance with the UE mobility procedure, the plurality of reference signals comprising a first subset of reference signals associated with the first resource set and a second subset of reference signals associated with the second resource set; and transmitting a group-based measurement report for the candidate cell, the group-based measurement report indicating one or more measurements of the plurality of reference signals associated with the candidate cell based at least in part on monitoring the first and second resource sets.

Aspect 2: The method of aspect 1, further comprising: receiving a first reference signal of the first subset of reference signals via one or more time resources of the first resource set based at least in part on the monitoring; and receiving a second reference signal of the second subset of reference signals via one or more time resources of the second resource set that at least partially overlap in time with the one or more time resources of the first resource set based at least in part on the monitoring.

Aspect 3: The method of aspect 2, wherein transmitting the group-based measurement report comprises: transmitting a first reference signal receive power value associated with the first reference signal based at least in part on the monitoring; and transmitting a second reference signal receive power value associated with the second reference signal based at least in part on the monitoring.

Aspect 4: The method of any of aspects 1 through 3, wherein transmitting the group-based measurement report comprises: transmitting the group-based measurement report based at least in part on a priority rule for group-based channel measurement reporting.

Aspect 5: The method of aspect 4, wherein the group-based measurement report for the candidate cell is associated with a first cell identifier and a second report is associated with a second cell identifier, the second report scheduled for transmission via time resources that at least partially overlap the group-based measurement report, wherein transmitting the group-based measurement report comprises: transmitting the group-based measurement report via the time resources based at least in part on the first cell identifier being smaller than the second cell identifier in accordance with the priority rule.

Aspect 6: The method of any of aspects 1 through 5, wherein receiving the control signal comprises: receiving the control signal indicating a first cell identifier associated with the candidate cell.

Aspect 7: The method of aspect 6, wherein receiving the control signal comprises: receiving the control signal via a field in a radio resource control message.

Aspect 8: The method of any of aspects 6 through 7, wherein receiving the control signal comprises: receiving the control signal indicating a channel state information reference signal associated with the candidate cell.

Aspect 9: The method of aspect 8, wherein a configuration corresponding to the channel state information reference signal indicates that the first resource set and the second resource set are associated with the candidate cell.

Aspect 10: The method of any of aspects 1 through 9, wherein receiving the control signal comprises: receiving the control signal via a serving cell.

Aspect 11: The method of any of aspects 1 through 10, further comprising: receiving the control signaling indicating a third resource set and a fourth resource set that are allocated to the UE for group-based channel measurement reporting for the UE mobility procedure, wherein both the third resource set and the fourth resource set are associated with a second cell for the UE mobility procedure: monitoring the third and fourth resource sets for a second plurality of reference signals associated with the second cell in accordance with the UE mobility procedure, the second plurality of reference signals comprising a third subset of reference signals associated with the third resource set and a fourth subset of reference signals associated with the fourth resource set; and transmitting the group-based measurement report for the second cell, the group-based measurement report indicating one or more measurements of the second plurality of reference signals associated with the second cell based at least in part on monitoring the third and fourth resource sets.

Aspect 12: The method of aspect 11, further comprising: receiving a first reference signal pair associated with the plurality of reference signals via one or more time resources of the first and second resource sets based at least in part on the monitoring; and receiving a second reference signal pair associated with the second plurality of reference signals via one or more time resources of the third and fourth resource sets that at least partially overlap in time with the one or more time resources of the first and second resource sets, wherein the UE is capable of receiving each reference signal of the first reference signal pair and each reference signal of the second reference signal pair over the one or more overlapping time resources based at least in part on the monitoring.

Aspect 13: The method of any of aspects 11 through 12, wherein the second cell is associated with a second candidate cell or a serving cell.

Aspect 14: The method of any of aspects 11 through 13, wherein the candidate cell and the second cell are associated with a same frequency or a same intra-frequency measurement as a serving cell.

Aspect 15: The method of any of aspects 11 through 14, wherein the candidate cell and the second cell are associated with a different frequency or a different intra-frequency measurement as a serving cell.

Aspect 16: The method of any of aspects 11 through 15, wherein the third resource set is associated with a first set of transmission beams for the third subset of reference signals and the fourth resource set is associated with a second set of transmission beams for the fourth subset of reference signals.

Aspect 17: The method of any of aspects 11 through 16, wherein the third resource set is associated with a first channel measurement resource set and the fourth resource set is associated with a second channel measurement resource set.

Aspect 18: The method of any of aspects 1 through 17, wherein the first resource set is associated with a first set of transmission beams for the first subset of reference signals and the second resource set is associated with a second set of transmission beams for the second subset of reference signals.

Aspect 19: The method of any of aspects 1 through 18, wherein the first resource set comprises a first channel measurement resource set or a first interference measurement resource set and the second resource set comprises a second channel measurement resource set or a second interference measurement resource set.

Aspect 20: The method of any of aspects 1 through 19, wherein receiving the control signal comprises: receiving the control signal via a layer 1 (L1) message or a layer 2 (L2) message, wherein the UE mobility procedure comprises an L1/L2 triggered mobility (LTM) procedure.

Aspect 21: The method of aspect 20, wherein receiving the control signal comprises: receiving the control signal via the layer 1 message, the layer 1 message comprising a downlink control information: or receiving the control signal via the layer 2 message, the layer 2 message comprising a medium access control (MAC) control element (MAC-CE).

Aspect 22: The method of any of aspects 1 through 21, wherein the candidate cell is associated with a deactivated serving cell or a non-serving cell.

Aspect 23: A method for wireless communications at a UE, comprising: receiving a control signal indicating a first resource set and a second resource set that are allocated to the UE for group-based channel measurement reporting for a UE mobility procedure, wherein the first resource set is associated with a candidate cell for the UE mobility procedure and the second resource set is associated with a second cell for the UE mobility procedure: monitoring the first resource set for a first plurality of reference signals associated with the candidate cell in accordance with the UE mobility procedure and the second resource set for a second plurality of reference signals associated with the second cell in accordance with the UE mobility procedure; and transmitting a group-based measurement report indicating one or more measurements of the first plurality of reference signals associated with the candidate cell and one or more measurements of the second plurality of reference signals associated with the second cell based at least in part on monitoring the first and second resource sets.

Aspect 24: The method of aspect 23, wherein the first and second resource sets are each associated with multiple cells.

Aspect 25: The method of any of aspects 23 through 24, wherein transmitting the group-based measurement report comprises: transmitting one or more reference signal identifiers associated with the first plurality of reference signals and one or more reference signal identifiers associated with the second plurality of reference signals; and transmitting one or more reference signal receive power values associated with the first plurality of reference signals and one or more reference signal receive power values associated with the second plurality of reference signals.

Aspect 26: The method of any of aspects 23 through 25, wherein the first plurality of reference signals is associated with a first set of transmission beams and the second plurality of reference signals is associated with a second set of transmission beams.

Aspect 27: A method for wireless communications at a first wireless device, comprising: transmitting, to a UE, a control signal indicating a first resource set and a second resource set that are allocated to the UE for group-based channel measurement reporting for a UE mobility procedure, wherein both the first resource set and the second resource set are associated with a candidate cell for the UE mobility procedure; and receiving, from the UE, a group-based measurement report for the candidate cell, the group-based measurement report indicating one or more measurements of a plurality of reference signals associated with the candidate cell based at least in part on monitoring the first and second resource sets, wherein the first and second resource sets comprise the plurality of reference signals, and wherein the plurality of reference signals comprises a first subset of reference signals associated with the first resource set and a second subset of reference signals associated with the second resource set.

Aspect 28: The method of aspect 27, further comprising: transmitting, to the UE, a control message indicating the UE to switch to the candidate cell.

Aspect 29: An apparatus for wireless communications at a UE, comprising a processor; memory coupled with the processor; and instructions stored in the memory and executable by the processor to cause the apparatus to perform a method of any of aspects 1 through 22.

Aspect 30: An apparatus for wireless communications at a UE, comprising at least one means for performing a method of any of aspects 1 through 22.

Aspect 31: A non-transitory computer-readable medium storing code for wireless communications at a UE, the code comprising instructions executable by a processor to perform a method of any of aspects 1 through 22.

Aspect 32: An apparatus for wireless communications at a UE, comprising a processor: memory coupled with the processor; and instructions stored in the memory and executable by the processor to cause the apparatus to perform a method of any of aspects 23 through 26.

Aspect 33: An apparatus for wireless communications at a UE, comprising at least one means for performing a method of any of aspects 23 through 26.

Aspect 34: A non-transitory computer-readable medium storing code for wireless communications at a UE, the code comprising instructions executable by a processor to perform a method of any of aspects 23 through 26.

Aspect 35: An apparatus for wireless communications at a first wireless device, comprising a processor: memory coupled with the processor; and instructions stored in the memory and executable by the processor to cause the apparatus to perform a method of any of aspects 27 through 28.

Aspect 36: An apparatus for wireless communications at a first wireless device, comprising at least one means for performing a method of any of aspects 27 through 28.

Aspect 37: A non-transitory computer-readable medium storing code for wireless communications at a first wireless device, the code comprising instructions executable by a processor to perform a method of any of aspects 27 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a control signal indicating a first resource set and a second resource set that are allocated to the UE for group-based channel measurement reporting for a UE mobility procedure, wherein both the first resource set and the second resource set are associated with a candidate cell for the UE mobility procedure;
monitor the first and second resource sets for a plurality of reference signals associated with the candidate cell in accordance with the UE mobility procedure, the plurality of reference signals comprising a first subset of reference signals associated with the first resource set and a second subset of reference signals associated with the second resource set; and
transmit a group-based measurement report for the candidate cell, the group-based measurement report indicating one or more measurements of the plurality of reference signals associated with the candidate cell based at least in part on monitoring the first and second resource sets.

2. The apparatus of claim 1, wherein the instructions are further executable by the processor to cause the apparatus to:
receive a first reference signal of the first subset of reference signals via one or more time resources of the first resource set based at least in part on the monitoring; and
receive a second reference signal of the second subset of reference signals via one or more time resources of the second resource set that at least partially overlap in time with the one or more time resources of the first resource set based at least in part on the monitoring.

3. The apparatus of claim 2, wherein the instructions to transmit the group-based measurement report are executable by the processor to cause the apparatus to:
transmit a first reference signal receive power value associated with the first reference signal based at least in part on the monitoring; and
transmit a second reference signal receive power value associated with the second reference signal based at least in part on the monitoring.

4. The apparatus of claim 1, wherein the instructions to transmit the group-based measurement report are executable by the processor to cause the apparatus to:
transmit the group-based measurement report based at least in part on a priority rule for group-based channel measurement reporting.

5. The apparatus of claim 4, wherein the group-based measurement report for the candidate cell is associated with a first cell identifier and a second report is associated with a second cell identifier, the second report scheduled for transmission via time resources that at least partially overlap the group-based measurement report, wherein the instructions to transmit the group-based measurement report are executable by the processor to cause the apparatus to:
transmit the group-based measurement report via the time resources based at least in part on the first cell identifier being smaller than the second cell identifier in accordance with the priority rule.

6. The apparatus of claim 1, wherein the instructions to receive the control signal are executable by the processor to cause the apparatus to:
receive the control signal indicating a first cell identifier associated with the candidate cell.

7. The apparatus of claim 6, wherein the instructions to receive the control signal are executable by the processor to cause the apparatus to:
receive the control signal via a field in a radio resource control message.

8. The apparatus of claim 6, wherein the instructions to receive the control signal are executable by the processor to cause the apparatus to:
receive the control signal indicating a channel state information reference signal associated with the candidate cell.

9. The apparatus of claim 8, wherein a configuration corresponding to the channel state information reference signal indicates that the first resource set and the second resource set are associated with the candidate cell.

10. The apparatus of claim 1, wherein the instructions to receive the control signal are executable by the processor to cause the apparatus to:
receive the control signal via a serving cell.

11. The apparatus of claim 1, wherein the instructions are further executable by the processor to cause the apparatus to:
receive the control signal indicating a third resource set and a fourth resource set that are allocated to the UE for group-based channel measurement reporting for the UE mobility procedure, wherein both the third resource set and the fourth resource set are associated with a second cell for the UE mobility procedure;
monitor the third and fourth resource sets for a second plurality of reference signals associated with the second cell in accordance with the UE mobility procedure, the second plurality of reference signals comprising a third subset of reference signals associated with the third resource set and a fourth subset of reference signals associated with the fourth resource set; and
transmit the group-based measurement report for the second cell, the group-based measurement report indicating one or more measurements of the second plurality of reference signals associated with the second cell based at least in part on monitoring the third and fourth resource sets.

12. The apparatus of claim 11, wherein the instructions are further executable by the processor to cause the apparatus to:
receive a first reference signal pair associated with the plurality of reference signals via one or more time resources of the first and second resource sets based at least in part on the monitoring; and
receive a second reference signal pair associated with the second plurality of reference signals via one or more time resources of the third and fourth resource sets that at least partially overlap in time with the one or more time resources of the first and second resource sets, wherein the UE is capable of receiving each reference signal of the first reference signal pair and each reference signal of the second reference signal pair over the one or more overlapping time resources based at least in part on the monitoring.

13. The apparatus of claim 11, wherein the second cell is associated with a second candidate cell or a serving cell.

14. The apparatus of claim 11, wherein the candidate cell and the second cell are associated with a same frequency or a same intra-frequency measurement as a serving cell.

15. The apparatus of claim 11, wherein the candidate cell and the second cell are associated with a different frequency or a different intra-frequency measurement as a serving cell.

16. The apparatus of claim 11, wherein the third resource set is associated with a first set of transmission beams for the third subset of reference signals and the fourth resource set is associated with a second set of transmission beams for the fourth subset of reference signals.

17. The apparatus of claim 11, wherein the third resource set is associated with a first channel measurement resource set and the fourth resource set is associated with a second channel measurement resource set.

18. The apparatus of claim 1, wherein the first resource set is associated with a first set of transmission beams for the first subset of reference signals and the second resource set is associated with a second set of transmission beams for the second subset of reference signals.

19. The apparatus of claim 1, wherein the first resource set comprises a first channel measurement resource set or a first interference measurement resource set and the second resource set comprises a second channel measurement resource set or a second interference measurement resource set.

20. The apparatus of claim 1, wherein the instructions to receive the control signal are executable by the processor to cause the apparatus to:
receive the control signal via a layer 1 (L1) message or a layer 2 (L2) message, wherein the UE mobility procedure comprises an L1/L2 triggered mobility (LTM) procedure.

21. The apparatus of claim 20, wherein the instructions to receive the control signal are executable by the processor to cause the apparatus to:
receive the control signal via the layer 1 message, the layer 1 message comprising a downlink control information: or
receive the control signal via the layer 2 message, the layer 2 message comprising a medium access control (MAC) control element (MAC-CE).

22. The apparatus of claim 1, wherein the candidate cell is associated with a deactivated serving cell or a non-serving cell.

23. An apparatus for wireless communications at a user equipment (UE), comprising:
a processor;
memory coupled with the processor; and
instructions stored in the memory and executable by the processor to cause the apparatus to:
receive a control signal indicating a first resource set and a second resource set that are allocated to the UE for group-based channel measurement reporting for a UE mobility procedure, wherein the first resource set is associated with a candidate cell for the UE mobility procedure and the second resource set is associated with a second cell for the UE mobility procedure;
monitor the first resource set for a first plurality of reference signals associated with the candidate cell in accordance with the UE mobility procedure and the second resource set for a second plurality of reference signals associated with the second cell in accordance with the UE mobility procedure; and
transmit a group-based measurement report indicating one or more measurements of the first plurality of reference signals associated with the candidate cell and one or more measurements of the second plurality of reference signals associated with the second cell based at least in part on monitoring the first and second resource sets.

24. The apparatus of claim 23, wherein the first and second resource sets are each associated with multiple cells.

25. The apparatus of claim 23, wherein the instructions to transmit the group-based measurement report are executable by the processor to cause the apparatus to:
transmit one or more reference signal identifiers associated with the first plurality of reference signals and one or more reference signal identifiers associated with the second plurality of reference signals; and
transmit one or more reference signal receive power values associated with the first plurality of reference signals and one or more reference signal receive power values associated with the second plurality of reference signals.

26. The apparatus of claim 23, wherein the first plurality of reference signals is associated with a first set of transmission beams and the second plurality of reference signals is associated with a second set of transmission beams.

27. An apparatus for wireless communications at a first wireless device, comprising:
a processor;
memory coupled with the processor; and
instructions stored in the memory and executable by the processor to cause the apparatus to:
transmit, to a UE, a control signal indicating a first resource set and a second resource set that are allocated to the UE for group-based channel measurement reporting for a UE mobility procedure, wherein both the first resource set and the second resource set are associated with a candidate cell for the UE mobility procedure; and
receive, from the UE, a group-based measurement report for the candidate cell, the group-based measurement report indicating one or more measurements of a plurality of reference signals associated with the candidate cell based at least in part on monitoring the first and second resource sets, wherein the first and second resource sets comprise the plurality of reference signals, and wherein the plurality of reference signals comprises a first subset of reference signals associated with the first resource set and a second subset of reference signals associated with the second resource set.

28. The apparatus of claim 27, wherein the instructions are further executable by the processor to cause the apparatus to:
transmit, to the UE, a control message indicating the UE to switch to the candidate cell.

29. A method for wireless communications at a user equipment (UE), comprising:
receiving a control signal indicating a first resource set and a second resource set that are allocated to the UE for group-based channel measurement reporting for a UE mobility procedure, wherein both the first resource set and the second resource set are associated with a candidate cell for the UE mobility procedure;
monitoring the first and second resource sets for a plurality of reference signals associated with the candidate cell in accordance with the UE mobility procedure, the plurality of reference signals comprising a first subset of reference signals associated with the first resource set and a second subset of reference signals associated with the second resource set; and
transmitting a group-based measurement report for the candidate cell, the group-based measurement report indicating one or more measurements of the plurality of reference signals associated with the candidate cell based at least in part on monitoring the first and second resource sets.

30. The method of claim 29, further comprising:
receiving a first reference signal of the first subset of reference signals via one or more time resources of the first resource set based at least in part on the monitoring; and
receiving a second reference signal of the second subset of reference signals via one or more time resources of the second resource set that at least partially overlap in time with the one or more time resources of the first resource set based at least in part on the monitoring.
